(19) United States
(12) Patent Application Publication
(10) Pub. No.: US 2016/0083592 A1
(43) Pub. Date: Mar. 24, 2016

(54) NOVEL POLYSILOXANE-BASED FOULING-RELEASE COATS

(71) Applicant: HEMPEL A/S, Kgs. Lyngby (DK)

(72) Inventors: Stefan Møller OLSEN, Virum (DK); Peter Christian Weinrich THORLAKSEN, Solrød Strand (DK); Diego Meseguer YEBRA, Ripollet (ES)

(73) Assignee: HEMPEL A/S, Kgs. Lyngby (DK)

(21) Appl. No.: 14/787,180

(22) PCT Filed: May 2, 2014
(86) PCT No.: PCT/DK2014/050119

§ 371 Date: Oct. 26, 2015

(30) Foreign Application Priority Data
May 3, 2013 (EP) 13166479.9

(51) Int. Cl. C09D 5/16

(52) U.S. Cl. CPC C09D 5/1675; C09D 5/1687; C09D 5/1637; C09D 5/1693

(57) ABSTRACT

The present application discloses a silicone-based fouling-release coat comprising a polysiloxane-based binder matrix constituting at least 40% by dry weight of said coat, wherein more than 65% by weight of said the binder matrix is represented by polysiloxane parts, said binder matrix of said coat having included as a part thereof zwitterionic moieties and/or said coat comprising one or more zwitterionic compounds. In some embodiments, the coat further comprises one or more active ingredients selected from biocides and enzymes, in particular biocides. The application also relates to corresponding coating compositions (paints), coating systems and to the use of the combination of constituents having included one or more zwitterionic functionalities and one or more active ingredients selected from biocides and enzymes, for improving the antifouling properties of a polysiloxane based coating composition.

### FIELD OF THE INVENTION

The present invention relates to novel silicone-based fouling-release coatings having included as part thereof zwitterionic moieties and/or comprising one or more zwitterionic compounds, as well as to coating systems comprising a coat having included such zwitterionic moieties/compounds.

### BACKGROUND OF THE INVENTION

Traditionally, silicone formulations rely on physical means, this being mainly a factor of modulus of elasticity and surface tension to create a low bio-fouling surface. The traditional polydimethylsiloxane (PDMS) coatings have shown difficulty in resisting bio-fouling over time, thus decreasing the advantage of drag reduction.

Hence, there is a need for fouling-release polysiloxane-based coating compositions combining the benefits of conventional polysiloxane-based fouling-release coating compositions with the benefits of biocide-based antifouling coating compositions. Coatings providing improved stability as compared to conventional coatings are also needed, because such coatings will be particularly useful for long-term application in complex media.

The silicone based fouling-release coatings have demonstrated an advantage over conventional antifouling coatings showing significant lower drag resistance, hence reduced fuel consumption of marine vessels. The difference is especially obvious as long as the silicone coating is free from marine fouling including slime fouling. Many conventional silicone coatings have until now only been able to maintain a slime free surface for a shorter period.

A few biocide containing antifouling coatings have demonstrated a greater resistance towards marine fouling compared to the silicone based fouling-release coatings under e.g. static conditions. The surface characteristics of such a coating will however lead to an increased drag resistance compared to silicone coatings even when the surface is fouling free.

The rationale behind the present invention has been to prolong the slime free period of a silicone based coating by combining the biocidal components from the antifouling coatings with a silicone based fouling-release coating. This provides a coating with low drag resistance that will remain fouling free for a longer time than conventional silicone based fouling-release coatings.

Webster and co-workers (WO 2010/042804 A2, Webster et al., Polymer Preprints 2011, 52(2), 1032, and Bodkhe and Webster, Polymer Preprints 2011, 52(1), 359) have disclosed various linear amphiphilic/zwitterionic triblock- and pentablock copolymers based on a polysiloxane scaffold. Such copolymers are referred to as having anti-fouling properties.

WO 2009/067565 A2 discloses marine coatings based on cationic polymers (typically acrylate-based) hydrolysable to non-fouling zwitterionic polymers.

Lin et al., Acta Biomaterialia 7 (2011) 2053-2059, disclose biocompatible acrylic/silicone hybrid material useful for implants. The material is prepared by copolymerisation of an esterified carboxybetaine and a hydrophobic 3-methacryloxypropyl-tris(trimethylsiloxy)silane (TRIS). Upon contact with an hydrolysing environment, the esters near the outer surface of the otherwise hydrophobic matrix is gradually converted into a protein-resistant zwitterionic form of carboxybetaine.

Aldred et al., Biofouling, Vol. 26, No. 6, August 2010, 673-683, discloses the anti-settling effect of surfaces coated with polySBMA (poly(sulfobetaine methacrylate)) and polyCBMA (poly(carboxybetaine methacrylate)) on the marine organism banacle cyprids.

### SUMMARY OF THE INVENTION

In view of the above-mentioned needs, the present inventors have now developed paint compositions for preparing new fouling-release coatings (i.e. a cured paint coat) comprising a polysiloxane-based binder matrix having included as a part thereof zwitterionic moieties, and/or comprising one or more zwitterionic compounds, and optionally one or more biocides, which matrix/compounds provide excellent fouling-release properties and facilitate and control the leaching of any biocides. In this way, the advantages of silicone fouling-release can be combined with those of traditional anti-fouling coatings, thus gaining a foul-free, low-friction surface with the use of a relatively small amount of biocide.

Moreover, the inventors of the present invention surprisingly found, that fouling-release coatings (i.e. a cured paint coat) comprising a polysiloxane-based binder matrix having included as a part thereof zwitterionic moieties, and/or comprising one or more zwitterionic compounds, and optionally one or more biocides, will be less susceptible to oxidation damages than coatings including other hydrophilic moieties, such as e.g. polyethylene glycol (PEG). Accordingly, the coatings of the present invention will be particular useful for long-term application in complex media. Furthermore, such coatings are beneficial due to there capability of dramatically reducing bacterial attachment and biofilm formation. The coatings claimed herein are thus highly resistant to nonspecific protein adsorption.

The present inventors have i.a. realised that the use of a polysiloxane-based binder system having included as a part thereof zwitterionic moieties, and/or a coat comprising one or more zwitterionic compounds (see further below), renders it possible to obtain a media for water- and biocidal transport through the cured polysiloxane matrix film. The leach rate of the biocide can be controlled amongst others by the abundance of the zwitterions.

So, in a first aspect the present invention relates to a silicone-based fouling-release coat comprising a polysiloxane-based binder matrix constituting at least 40% by dry weight of said coat, wherein more than 65% by weight of the binder matrix is represented by polysiloxane parts, said binder matrix of said coat having included as a part thereof zwitterionic moieties and/or said coat comprising one or more zwitterionic compounds, and said coat preferably further comprising one or more active ingredients selected from biocides and enzymes, in particular one or more biocides, cf. e.g. claims 1 and 12.

Other aspects of the invention relates to a marine structure, cf. e.g. claim 6, fouling-release coating compositions, cf. e.g. claims 8 and 9, and various uses, cf. e.g. claims 10 and 11.

A still further aspect of the invention relates to a coating system, cf. e.g. claim 13.

Reading the below disclosure and examples, the skilled person will realize, that a few ratios, concentrations and other kind of measures explicitly refer to a ‘wet film’ or ‘wet thickness’. In those cases said ratio, concentration or measure applies immediate after application of the wet paint.

In other cases, a dry weight form basis for such ratio, concentration or other measure. In those cases said ratio, concentration or measure applies for a cured composition not yet exposed to marine conditions. Upon exposure to e.g. sea water such ratios, concentrations and other measures given (e.g. the concentration of active ingredients) will typically change as a consequence of the mechanism of action outlined herein above.

### DETAILED DISCLOSURE OF THE INVENTION

### Main Aspect of the Invention—the Fouling-Release Coat

The present invention i.a. relates to a fouling-release coat, in particular a silicone-based fouling-release coat comprising a polysiloxane-based binder matrix constituting at least 40% by dry weight of said coat, wherein more than 65% by weight of said binder matrix is represented by polysiloxane parts, said binder matrix of said coat having included as a part thereof zwitterionic moieties and/or said coat comprising one or more zwitterionic compounds. In one interesting embodiment hereof, the coat further comprises one or more active ingredients selected from biocides and enzymes, in particular one or more biocides, in particular in an amount of 1-15% by weight (see further below).

It should be understood that the expression “fouling-release” (as well as “fouling control”) relates to all types of bio-fouling of a surface (i.e. settlement of organisms on a surface), in particular surfaces exposed to an aqueous environment or to aqueous liquids (e.g. within tanks, pipes, etc.). It is however, believed that the coatings defined herein are particularly relevant for avoiding or reducing marine bio-fouling, i.e. bio-fouling arising in connection with the exposure of a surface to a marine environment, in particular to sea-water.

The fouling-release coat comprises a polysiloxane-based binder matrix constituting at least 40% by dry weight of said coat, and more than 65% by weight of the binder matrix is represented by polysiloxane parts. Often, this coat constitutes the outermost layer of the fouling-release coating system. Hence, it should be understood that the fouling-release coat may be prepared on an already existing coating layer, e.g. an anti-corrosive coating layer or a tie-coat layer, or directly on a native substrate. Alternatively, the coat may prepared on a substrate (e.g. on a tie-coat or on a primer, or simply on a native substrate) and may subsequently be over-coated with a top-coat.

### The Polysiloxane-Based Binder Matrix

It should be understood that the polysiloxane-based binder matrix is made up of reactive polysiloxane binder components, e.g. functional organopolysiloxanes (such as polydialkylsiloxane, polyarylsiloxane, polyalkylaryl siloxane or combinations thereof), cross-linkers, silicates (e.g. ethyl silicate), and the like. Thus, it is believed that the reaction between such components will result in the binder matrix in the form of a typically three-dimensional covalently interconnected network. Hence, the polysiloxane-based binder matrix is cross-linked.

The cured paint coat may be formed in various ways, e.g. polymerization/cross-linking by formation of siloxane bonds through a condensation reaction or by the use of their reactive groups such as for example amine/epoxy, carbinol/isocyanate etc. A condensation reaction is preferred.

The polysiloxane-based binder matrix is prepared from a polysiloxane based binder which is a functional organopolysiloxane, with terminal and/or pendant functionality. The terminal functionality is preferred. The functionality can either be hydrolysable groups, such as for example alkoxy groups, ketoxime groups or the functionality can be silanol groups. A minimum of two reactive groups per molecule is preferred. If the molecule contains only two reactive groups, for example silanol groups, it may be necessary to use an additional reactant, a cross-linker, to obtain the desired cross-link density. The cross-linker can for example be an alkoxy silane such as methyltrimethoxysilane, but a wide range of useful silanes are available as will be described further on. The silane can be used as it is or as hydrolysation-condensation products of same. Although condensation cure is much preferred, the functionality of the organopolysiloxane is not limited to a condensation cure. If so desired, other types of curing can be utilized, for example amine/epoxy either alone or in combination with a condensation reaction. In such cases, the organopolysiloxane can have terminal groups of epoxy or amine and pendant hydrolysable groups, for example with alkoxyfunctionality.

In some embodiments, the fouling-release coating composition (i.e. a composition for the preparation of the fouling-release coat) including the polysiloxane-based binder system may be a reaction-curable composition or a condensation-curable composition as will be evident for the person skilled in the art. Examples hereof are a two-component condensation curing composition based on a silanol-reactive polydiorganosiloxane and a silane with hydrolysable groups, or a one-component condensation-curable composition based on a polydiorganosiloxane with alkoxy or other hydrolysable reactivity. Another example is a reaction curable composition based on an epoxyfunctional polysiloxane binder and an amine functional polysiloxane curing agent. Combinations of reaction-curable compositions and condensation-curable compositions are possible, if the binder or the curing agent (or both) includes condensation curable groups, such as alkoxy groups.

In one embodiment, the binder phase comprises (i) a binder and (ii) a cross-linking agent of which the binder (i) should include hydrolysable groups or other reactive groups so as to participate in the formation of the matrix.

The binder (i) typically constitutes 40-90% by dry weight of the coating composition.

The cross-linking agent (ii) preferably constitutes 0-10% by dry weight of the coating composition and is, e.g., an organosilicon compound represented by the general formula (2) shown below, a partial hydrolysis-condensation product thereof, or a mixture of the two:

Rₐ—Si—X₄₋ₐ (2)

wherein, each R represents, independently, an unsubstituted or substituted monovalent hydrocarbon group of 1 to 6 carbon atoms or a hydrolysable group, each X represents, independently, a hydrolysable group, and a represents an integer from 0 to 2, such as from 0 to 1.

Within the art of polymer chemistry, it is well-known that the term ‘partial hydrolysis-condensation product’ refers to such compound wherein the compound has been allowed to react with itself in a condensation reaction creating oligomer or polymer. However still retaining the reactive/hydrolysable groups used in the cross-linking reaction.

The compound outlined in formula (2) acts as a cross-linker for the binder (i). The composition can be formulated as a one component curable RTV (room-temperature vulcanizable) by admixing the binder (i) and the cross-linking agent (ii). If the reactivity on the terminal Si-group of the binder (i) consist of readily hydrolysable groups, such as dimethoxy or trimethoxy, a separate cross-linker is usually not necessary to cure the film. The technology behind the curing mechanism and examples of cross-linkers is described in prior art (US 2004/006190).

In one embodiment, R represents a hydrophilic group such as a poly(oxyalkylene). In this case, it is preferred to have a C₂₋₅-alkyl spacer between the Si-atom and the polyoxyalkylene group. Hence, the organopolysiloxane may have oxyalkylene domains.

Preferred cross-linkers are those selected from tetramethoxysilane, tetraethoxysilane; tetrapropoxysilane; tetra-n-butoxysilane; vinyltris(methylethyloximino)silane; vinyltris-(acetoxime)silane; methyltris(methylethyloximino)silane; methyltris(acetoxime)silane; vinyltrimethoxysilane; methyltrimethoxysilane; vinyltris(isopropenoxy)silane; tetraacetoxy-silane; methyltriacetoxysilane; ethyltriacetoxysilane; vinyltriacetoxysilane; di-t-butoxy-diacetoxysilane; methyltris(ethyllactate)silane and vinyltris(ethyllactate)silane as well as hydrolysis-condensation products of the same.

More preferred cross-linkers are tetraethoxysilane; vinyltris(methylethyloximino)silane; methyltris(methylethyloximino)silane; vinyltrimethoxysilane; methyltris(methylethyloximino)silane; methyltris(ethyllactate)silane vinyltris(ethyllactate)silane as well as hydrolysis-condensation products of the same.

More preferred cross-linkers are tetraethoxysilane; vinyltrimethoxysilane; methyltris(ethyllactate)silane vinyltris(ethyllactate)silane as well as hydrolysis-condensation products of the same. In a specific embodiment, said cross-linker is tetraethoxysilane or a hydrolysis-condensation product thereof. In another specific embodiment, said cross-linker is vinyltrimethoxysilane or a hydrolysis condensation product thereof. In yet another specific embodiment, said cross-linker is methyltris(ethyllactate)silane or a hydrolysis-condensation product thereof. In yet another specific embodiment, said cross-linker is thervinyltris(ethyllactate)silane or a hydrolysis-condensation products thereof. In one further embodiment, said cross-linker is a hydrolysis-condensation product. In another embodiment, said cross-linker is not a hydrolysis-condensation product.

Other interesting cross-linkers are those selected from vinyltriethoxysilane, methyltriethoxy-silane, ethyltrimethoxysilane, ethyltrimethoxysilane, tetraisopropoxysilane, tetrabutoxysilane as well as hydrolysis-condensation products of the same.

The term ‘polysiloxane’ is well-known to designate such polymers having a backbone in which atoms of silicon and oxygen alternate and which is devoid of carbon atoms (The New Encyclopedia Britannica in 30 volumes micropaedia volume IX. 1975 defining polysiloxane by referral to silicone). Similarly, the term polyorganosiloxane is intended to mean a polysiloxane backbone with organic (i.e. carbon-based) substituent on the silicon atoms.

In some interesting embodiments, the polysiloxane-based binder comprises a polydimethyl-siloxane-based binder.

In other interesting embodiments, the binder may include fluoro-modifications, e.g. fluoroalkyl modified polysiloxane binders such as silanol-terminated poly(trifluoropropyl-methylsiloxane).

The polysiloxane-based binder matrix typically constitutes at least 40% by dry weight, at least 50% by dry weight, preferably at least 60% by dry weight, e.g. at least 70% by weight, in particular 50-90% by dry weight, or 50-98% by dry weight, e.g. 50-96% by dry weight, in particular 60-95% by dry weight, or 50-95% by dry weight, or 60-94% by dry weight, or 70-96% by dry weight, or even 70-94% by dry weight, or 75-93% by dry weight, or 75-92% by dry weight, of the coating composition or of the cured coat.

The binder is in the form of a cross-linked matrix which incorporates other constituents, e.g. additives, pigments, fillers, etc., as well as any zwitterionic compounds (see below), any hydrophilic-modified polysiloxane oil(s), any biocide(s) and any enzyme(s) (see below), in the fouling-release coat.

The term “polysiloxane-based binder matrix” is intended to mean that the binder matrix mainly consists of polysiloxane parts, i.e. that more than 65% by weight, preferably more than 70% by weight, e.g. more than 75% by weight, of the binder matrix is represented by polysiloxane parts. Preferably the polysiloxane parts constitute 65-100% by weight, e.g. 65-99.9% by weight, in particular 70-100% by weight, or 70-99% by weight, or 70-98% by weight, or 75-97% by weight, or even 75-99% by weight, or 80-98% by weight, or 90-97% by weight, of the binder matrix (i.e. the binder components and any cross-linkers). The remainder of the binder matrix may e.g.—if present—be made of any zwitterionic moieties, any hydrophilic oligomer/polymer moieties and any (non-polysiloxane-type) cross-linkers.

When calculating the amount of the polysiloxane parts and any other parts (e.g. any zwitterionic moieties), respectively, for a given starting material (or an adduct), it is typically fairly straightforward to distinguish between the two. However, in order to eliminate any doubt about any linkers between the two, it should be understood that the zwitterionic moieties include all atoms up to, but not including, the silicon atom through which the zwitterionic moiety is covalently attached to the polysiloxane parts. Correspondingly, in order to eliminate any doubt about any linkers between the two, it should be understood that the polysiloxane modifications include all atoms up to, but not including, the silicon atom through which the modification is covalently attached to the polysiloxane parts. As an example, in a structure of the type [polysiloxane-O]—Si(Me)₂-CH₂CH₂CH₂-[zwitterionic moiety], the [polysiloxane-O]—Si(Me)₂ part is accounted for as a silicone part, whereas the CH₂CH₂CH₂-[zwitterionic moiety] is accounted for as the zwitterionic moiety.

### Catalyst

The coating compositions used for forming the fouling-release may further comprise a condensation catalyst to accelerate the cross-linking. Examples of suitable catalysts include organometal- and metal salts of organic carboxylic acids, such as dibutyl tin dilaurate, dibutyl tin diacetate, dibutyl tin dioctoate, dibutyl tin 2-ethylhexanoate, dioctyl tin dilaurate, dioctyl tin diacetate, dioctyl tin dioctoate, dioctyl tin 2-ethylhexanoate, dioctyltin di neodecanoate, tin naphthenate, tin butyrate, tin oleate, tin caprylate, bismuth 2-ethylhexanoate, bismuth octanoate, bismuth neodecanoate, iron 2-ethylhexanoate, lead 2-ethyloctoate, cobalt-2-ethylhexanoate, manganese 2-ethylhexanoate, zinc 2-ethylhexanoate, zinc naphthenate, zinc stearate, cobalt naphthenate and titanium naphtenate; titanate- and zirconate esters such as tetrabutyl titanate, tetrakis(2-ethylhexyl)titanate, triethanolamine titanate, tetra(isopropenoxy)titanate, titanium tetrabutanolate, titanium tatrapropanolate; titanium tetraisopropanolate, zirconium tetrapropanolate, zirconium tetrabutanolate; chelated titanates such as diisopropyl bis(acetylacetonyl)titanate. Further catalysts include tertiary amines, such as triethylamine, tetrametylethylenediamine, pentamethyldiethylenetriamine and 1,4-ethylenepiperazine. Further examples include guanidine based catalysts. Even further examples of condensation catalysts are described in WO 2008/132196 and US 2004/006190.

The catalyst may be used alone or as combination of two or more catalysts. In an embodiment, said catalyst(s) are selected from the group consisting of tin and titanium oxide(s) (titanate(s)). In one specific embodiment, said catalyst is tin-based. In one embodiment, a catalyst is included, which is devoid of tin. In another embodiment, said catalyst comprises one or more titanium oxide(s) (titanate(s)). The amount of catalyst to be used is depending on the reactivity of the catalyst and the cross-linker(s) and desired drying time. In a preferred embodiment the catalyst concentration is between 0.01-10%, e.g. 0.01-3.0%, or 5.0-10%, or 0.1-4.0%, or 1.0-6.0%, by weight of the total combined amount of the binder (i) and cross-linking agent (ii).

In some embodiments, a catalyst is not included.

### Solvents, Additives, Pigments and Fillers

The coating composition used for forming the fouling-release coat may further comprise solvents and additives.

Examples of solvents are aliphatic, cycloaliphatic and aromatic hydrocarbons such as white spirit, cyclohexane, toluene, xylene and naphtha solvent, esters such as methoxypropyl acetate, n-butyl acetate and 2-ethoxyethyl acetate; octamethyltrisiloxane, and mixtures thereof. Alternatively, the solvent system may include water or be water-based (>50% water in the solvent system).

In one embodiment, the solvents are selected from aliphatic, cycloaliphatic and aromatic hydrocarbons such as white spirit, cyclohexane, toluene, xylene and naphtha solvent, esters such as methoxypropyl acetate, n-butyl acetate and 2-ethoxyethyl acetate; octamethyltrisiloxane, and mixtures thereof, preferably those solvents having a boiling point of 110° C. or more.

The solvents, if any, typically constitute 5-50% by volume of the coating composition.

Examples of additives are:

(i) non-reactive fluids such as organopolysiloxanes; for example polydimethylsiloxane, methylphenyl polysiloxane; petroleum oils and combinations thereof;

(ii) surfactants such as derivatives of propylene oxide or ethylene oxide such as alkylphenol-ethylene oxide condensates (alkylphenol ethoxylates); ethoxylated monoethanolamides of unsaturated fatty acids such as ethoxylated monoethanolamides of linoleic acid; sodium dodecyl sulfate; and soya lecithin;

(iii) wetting agents and dispersants such as those described in M. Ash and I. Ash, “Handbook of Paint and Coating Raw Materials, Vol. 1”, 1996, Gower Publ. Ltd., Great Britain, pp 821-823 and 849-851;

(iv) thickeners and anti-settling agents (e.g. thixotropic agents) such as colloidal silica, hydrated aluminium silicate (bentonite), aluminium tristearate, aluminium monostearate, xanthan gum, chrysotile, pyrogenic silica, hydrogenated castor oil, organo-modified clays, polyamide waxes and polyethylene waxes;

(v) dyes such as 1,4-bis(butylamino)anthraquinone and other anthraquinone derivatives; toluidine dyes, etc.; and

(vi) antioxidants such as bis(tert-butyl) hydroquinone, 2,6-bis(tert-butyl) phenol, resorcinol, 4-tert-butyl catechol, tris(2,4-di-tert-butylphenyl)phosphite, pentaerythritol Tetrakis(3-(3,5-di-tert-butyl-4-hydroxyphenyl)propionate), bis(2,2,6,6,-tetramethyl-4-piperidyl)sebacate, etc.

Any additives typically constitute 0-30%, such as 0-15%, by dry weight of the coating composition or of the cured coat.

Preferably, the coating composition comprises one or more thickeners and/or anti-settling agents (e.g. thixotropic agents), preferably in an amount of 0.2-10%, such as 0.5-5%, e.g. 0.6-4%, by dry weight of the coating composition or of the cured coat.

Furthermore, the coating composition used for forming the fouling-release coat may comprise pigments and fillers.

Pigments and fillers are in the present context viewed in conjunction as constituents that may be added to the coating composition with only limited implications on the adhesion properties. “Pigments” are normally characterised in that they render the final paint coating non-transparent and non-translucent, whereas “fillers” normally are characterised in that they do not render the paint non-translucent and therefore do not contribute significantly to hide any material below the coating.

Examples of pigments are grades of titanium dioxide, red iron oxide, zinc oxide, carbon black, graphite, yellow iron oxide, red molybdate, yellow molybdate, zinc sulfide, antimony oxide, sodium aluminium sulfosilicates, quinacridones, phthalocyanine blue, phthalocyanine green, black iron oxide, indanthrone blue, cobalt aluminium oxide, carbazole dioxazine, chromium oxide, isoindoline orange, bis-acetoacet-o-tolidiole, benzimidazolon, quinaphtalone yellow, isoindoline yellow, tetrachloroisoindolinone, quinophthalone yellow.

Examples of fillers are calcium carbonate such as calcite, dolomite, talc, mica, feldspar, barium sulfate, kaolin, nephelin, silica, perlite, magnesium oxide, and quartz flour, etc. Fillers (and pigments) may also be added in the form of nanotubes or fibres, thus, apart from the before-mentioned examples of fillers, the coating composition may also comprise fibres, e.g. those generally and specifically described in WO 00/77102 which is hereby incorporated by reference.

Any pigments and/or fillers typically constitute 0-60%, such as 0-50%, preferably 5-45%, such as 5-40%, or 5-35%, or 0.5-25%, or 1-20%, by dry weight of the coating composition or of the cured coat. Taking into account the density of any pigments and/or fillers, such constituents typically constitute 0.2-20%, such as 0.5-15% by solids volume of the coating composition.

With the aim of facilitating easy application of the coating composition (e.g. by spray, brush or roller application techniques), the coating composition typically has a viscosity in the range of 25-25,000 mPa·s, such as in the range of 150-15,000 mPa·s, in particular in the range of 200-4,000 mPa·s.

### Hydrophilic Modifications

In some embodiments, the fouling-release coat may further have included as a part of the binder matrix hydrophilic oligomer/polymer moieties, or the fouling-release coat may comprise one or more hydrophilic-modified polysiloxane oils, or the coat may have included as a part of the binder matrix hydrophilic oligomer/polymer moieties and at the same time comprise one or more hydrophilic-modified polysiloxane oils. The inclusion (e.g. with respect to types, relative amounts, etc.) of oligomer/polymer moieties in the binder matrix and hydrophilic-modified polysiloxane oils in the coat is disclosed in detail in WO 2013/000479 A1, page 5, line 20, to page 18, line 23, page 22, line 3, to page 27, line 11, and page 37, line 6, to page 38, line 30, and in WO 2011/076856 A1, page 4, line 10, to page 10, line 29.

In another variant, the fouling-release coat may include hydrophilic-modified polysiloxane oils, i.e. constituents which do not form covalent bonds to the polysiloxane-based binder matrix. Hydrophilic-modified polysiloxane oils are widely used as surfactants and emulsifiers due to the content of both hydrophilic and lipophilic groups in the same molecule. In contrast to the polysiloxane components discussed above, the hydrophilic-modified polysiloxane oils are selected so that they do not contain groups that can react with the binder (or binder components) or the cross-linker (if present), hence the hydrophilic-modified polysiloxane oils are intended to be non-reactive, in particular with respect to the binder components. In particular, the hydrophilic-modified polysiloxane oils are devoid of any silicon-reactive groups such as Si—OH groups, hydrolysable groups such as Si—OR (such as alkoxy, oxime, acetoxy etc.) groups, etc., so as to avoid reaction with constituents of the polysiloxane-based binder system.

The non-reactive hydrophilic-modified polysiloxane oils are typically modified by the addition of non-ionic oligomeric or polymeric groups which can be polar and/or capable of hydrogen bonding, enhancing their interaction with polar solvents, in particular with water, or with other polar oligomeric or polymeric groups. Examples of these groups include, amides (e.g. poly(vinyl pyrrolidone), poly[N-(2-hydroxypropyl)methacrylamide]), poly(N,N-dimethacrylamide), acids (e.g. poly(acrylic acid)), alcohols (e.g. poly(glycerol), polyHEMA, polysaccharides, poly(vinyl alcohol)), ketones (polyketones), aldehydes (e.g. poly(aldehyde guluronate), amines (e.g. polyvinylamine), esters (e.g. polycaprolactones, poly(vinyl acetate)), ethers (e.g. polyoxyalkylenes like poly(ethylene glycol), poly(propylene glycol)), imides (e.g. poly(2-methyl-2-oxazoline)), etc., including copolymers of the foregoing. Preferably the hydrophilicity is obtained by modification with polyoxyalkylene groups.

In a preferred embodiment the groups are selected from ethers (e.g. polyoxyalkylenes like poly(ethylene glycol), poly(propylene glycol)), imides (e.g. poly(2-methyl-2-oxazoline)).

As before, it should be understood that the hydrophilic oligomer/polymer moieties with which the polysiloxane oils are modified are of non-silicon origin. Preferably, the above-mentioned “oligomers” and “polymers” include at least 3 repeating units, such as at least 5 repeating units. In many interesting embodiments, the oligomers or polymers include 3-1,000 repeating units, such as 3-200, or 5-150, or 5-100 repeating units. In another interesting embodiment the oligomers or polymers include 3-30 repeating units, such as 3-20 repeating units, such as 3 to 15 or even 4 to 12 repeating units. In yet another interesting embodiment the oligomers or polymers include 6 to 20 repeating units, such as 8 to 15 repeating units.

In some preferred embodiments, the hydrophilic groups (i.e. oligomeric or polymeric groups) have a number average molecular weight (Mₙ) in the range of 100-50,000 g/mol, such as in the range of 100-30,000 g/mol, in particular in the range of 200-20,000 g/mol, or in the range of 200-10,000 g/mol.

In other interesting embodiments the hydrophilic groups have a number average molecular weight (Mₙ) in the range of 200-5,000 g/mol, such as 200-2,500 g/mol or even 300-1,000 g/mol.

In the present description with claims, the term “hydrophilic-modified” in the context of “hydrophilic-modified polysiloxane oil” is intended to mean that the oligomeric or polymeric groups with which the polysiloxane is modified, in themselves (i.e. as discrete molecules) have a solubility of at least 1%(w/w) in demineralized water at 25° C.

Of particular interest are those hydrophilic-modified polysiloxane oils in which the relative weight of the hydrophilic moieties is 1% or more of the total weight (e.g. 1-90%), such as 5% or more (e.g. 5-80%), in particular 10% or more (e.g. 10-70%) of the total weight of the hydrophilic-modified polysiloxane oil.

In one embodiment the relative weight of the hydrophilic moieties is in the range of 25-60% such as 30-50% of the total weight of the hydrophilic-modified polysiloxane oil.

In a preferred embodiment, the hydrophilic-modified polysiloxane oil (if present) has a number average molecular weight (Mₙ) in the range of 100-100,000 g/mol, such as in the range of 250-75,000 g/mol, in particular in the range of 500-50,000 g/mol.

In another preferred embodiment, the hydrophilic-modified polysiloxane oil (if present) has a number average molecular weight (Mₙ) in the range of 500-20,000 g/mol, such as 1,000-10,000 g/mol or 1,000-7,500 g/mol or even 1,500-5,000 g/mol.

It is also preferred if the hydrophilic-modified polysiloxane oils (if present) have a viscosity in the range of 10-20,000 mPa·s, such as in the range of 20-10,000 mPa·s, in particular in the range of 40-5,000 mPa·s.

The hydrophilic-modified polysiloxane oils may be utilized to control the accessibility of the one or more enzymes and/or to control the leaching of any biocides, as well as to distribute the enzyme in the wet paint.

In one currently preferred embodiment, the hydrophilic-modified polysiloxane oil is a poly(oxyalkylene)-modified polysiloxane. In these embodiments and variants, the poly(oxyalkylene) is preferably selected from polyoxyethylene, polyoxypropylene and poly(oxyethylene-co-oxypropylene), which sometimes are referred to as poly(ethylene glycol), poly(propylene glycol) and poly(ethylene glycol-co-propylene glycol).

Commercially available hydrophilic-modified polysiloxane oils of this type are DC5103 (Dow Corning), DC Q2-5097 (Dow Corning), DC193 (Dow Corning), DC Q4-3669 (Dow Corning), DC Q4-3667 (Dow Corning), and DC2-8692.

If present, the one or more hydrophilic-modified polysiloxane oils are typically included in the coating composition (and in the cured coat) in an amount of 0.01-20%, e.g. 0.05-10%, by dry weight. In certain embodiments, the one or more hydrophilic-modified polysiloxane oils constitutes 0.05-7% by dry weight, e.g. 0.1-5% by dry weight, in particular 0.5-3% by dry weight, of the coating composition/cured coat. In certain other embodiments, the one or more hydrophilic-modified polysiloxane oils constitutes 1-10% by dry weight, e.g. 2-9% by dry weight, in particular 2-7% by dry weight, or 3-7% by dry weight, or 3-5% by dry weight, or 4-8% by dry weight, of the coating composition or of the cured coat.

### Zwitterionic Functionalities

It has been found beneficial to include zwitterionic functionalities in the fouling-release coat. Incorporation may either be as covalently linked moieties (i.e. zwitterionic moieties) or as non-covalently incorporated compounds (i.e. zwitterionic compounds). Hence, either said binder matrix of said coat has included zwitterionic moieties as a part thereof, or said coat comprises one or more zwitterionic compounds, or both. These two ways of incorporation of zwitterionic functionalities in the coat are further described below.

When used herein, the term “zwitterion” is intended to mean a dipolar functional group having a positive electrical charge and a negative electrical charge at different locations within the moiety, wherein the moiety is overall neutral (net charge of 0 (zero)).

It is understood that the positive electrical charge and the negative electrical charge are located sufficiently close to each other. It is therefore preferred that the positive electrical charge and the negative electrical charge are carried by atoms separated by less than 20 covalent atomic bonds, such as less than 15 covalent bonds, in particular less than 10 covalent bonds.

Examples of suitable zwitterionic functionalities are e.g. of the following types: phosphoryl cholines, e.g. of the formula

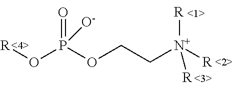

betaines, such carboxy betaines, e.g. of the formula

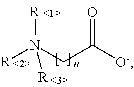

and
sulfo betaines, e.g. of the formula

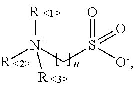

as well as derivatives of thereof.

In the above formulae, R<1>, R<2>, R<3> and R<4> may be the same of different and are typically selected from C₁₋₂₀-alkyl, C₃₋₂₀-alkenyl and aryl, and are optionally substituted by one or more substituents selected from —OH, —NH₂, —N(CH₃)₂, —SH, —SCH₃, etc.

The term “C₁₋₂₀-alkyl” as used herein refers to a saturated, straight or branched hydrocarbon chain containing from one to 20 carbon atoms, including methyl, ethyl, propyl, isopropyl, butyl, isobutyl, secondary butyl, tertiary butyl, pentyl, isopentyl, neopentyl, tertiary pentyl, hexyl, isohexyl, heptyl, octyl, decyl, etc. In some embodiments, the alkyl contains from one to four carbon atoms such as methyl, ethyl, propyl and butyl, in particular methyl.

The term “C₃₋₂₀-alkenyl” as used herein refers to a straight or branched hydrocarbon chain or cyclic hydrocarbons containing one or more double bonds, including di-enes, tri-enes and poly-enes, including 1- or 2-propenyl; 1-, 2- or 3-butenyl, or 1,3-but-dienyl; 1-, 2-, 3-, 4- or 5-hexenyl, or 1,3-hex-dienyl, or 1,3,5-hex-trienyl; 1-, 2-, 3-, 4-, 5-, 6-, or 7-octenyl, or 1,3-octadienyl, or 1,3,5-octatrienyl, or 1,3,5,7-octatetraenyl, etc.

The term “aryl”, as used herein includes carbocyclic aromatic ring systems derived from an aromatic hydrocarbon by removal of a hydrogen atom. Aryl furthermore includes bi-, tri- and polycyclic ring systems. Examples of preferred aryl moieties include phenyl, naphthyl, biphenyl, etc.

Also, it should be understood that the zwitterionic functionality in question may be represented as a latent zwitterion, e.g. like esters of quaternary ammonium compounds that upon hydrolysis exposes a carboxylic group rendering the moiety zwitterionic. Examples of such latent zwitterions are carboxy betaine esters, which are capable of being hydrolysed when exposed to water. In nother embodiment of the invention, the zwitterionic functionality in question is not represented as a latent zwitterion.

In one embodiment, the zwitterionic functionality/ies are incorporated as discrete compounds which do not become part of the polysiloxane-based binder matrix. Hence, in contrast to the zwitterionic moieties discussed below, the zwitterionic compounds are selected so that they do not contain groups that can react with the binder (or binder components) or the cross-linker (if present), hence the zwitterionic compounds are intended to be non-reactive, in particular with respect to the binder components. In a particular embodiment, said non-reactive zwitterionic compounds are devoid of reactive silanes.

As mentioned above, suitable zwitterionic compounds are e.g. those of the phosphorylcholine type, the sulfobetaine type and the carboxybetaine type, as well as derivatives thereof. As described above, the suitable zwitterionic compounds may be derived from compounds with latent zwitterion functionalities that will hydrolyse and become zwitterions upon use. In particular embodiments, said zwitterionic compounds are of the phosphorylcholine type. In other embodiments, said zwitterionic compounds are of the sulfobetaine type. In yet further embodiments, said zwitterionic compounds are of the carboxybetaine type.

The zwitterionic compounds may be added to the coating as discrete molecules (compounds), and each compound may include one or more zwitterion functionalities.

It will be clear to the person skilled in the art that the zwitterions are not included in the matrix as particles, hereunder nano-particles.

In some variants, the zwitterionic compounds are those having included only one zwitterionic functionality. Examples hereof are 3-1(1-pyridinio)-1-propanesulfonate, 3-(decyldimethyl-ammonio)propanesulfonate (Caprylyl sulfobetaine), 3-[(3-cholamidopropyl)dimethyl-ammonio]-1-propanesulfonate (CHAPS), dimethylethylammoniumpropanesulfonate, etc.

In some embodiments it is preferred that the zwitterionic compound moiety contains a hydrophobic moiety. Examples of such compounds are zwitterionic detergents, such as 3-(decyldimethylammonio)propanesulfonate (Caprylyl sulfobetaine), 3-[(3-cholamidopropyl)-dimethylammonio]-1-propanesulfonate (CHAPS).

It is preferred that zwitterionic compounds having only one zwitterionic functionality are relatively small compounds, preferably having a molecular weight of at the most 1,000 g/mol, such as at the most 750 g/mol.

Other examples are those zwitterionic compounds which encompass an unreactive polysiloxane moiety in addition to the zwitterion functionality/ies. Typically, the polysiloxane moiety has a number average molecular weight (Mₙ) in the range of 100-50,000 g/mol, such as in the range of 100-30,000 g/mol, in particular in the range of 200-20,000 g/mol, or in the range of 200-10,000 g/mol.

In other variants, the zwitterionic compounds are those having included two or more zwitterionic functionalities, e.g. dimers, trimers, oligomers and even polymers. For oligomers and polymers, it may be desirable that the polymer also contains hydrophobic monomer in addition to monomers carrying zwitterion functionalities. Examples of zwitterionic compounds having included two or more zwitterionic functionalities are poly(2-(methacryloyloxyethyl)-2-(trimethylammoniumethyl)phosphate, inner salt)-co-(N-dodecylmethacrylate) (1:2) (PC1059 ex. Vertellus) and poly(2-(methalcyloyloxyethyl)-2-(trimethylammoniumethyl) phosphate, inner salt)-co-(allyl methacrylate) (4:1) (PC1071 ex. Vertellus).

In the cases where the zwitterionic compounds are dimers, trimer, oligomers or polymer, i.e. comprising more than one zwitterion functionality per molecule, it is preferred that the zwitterion equivalent weight (i.e. calculated as the (weight average molecular weight of the dimer/trimer/oligomer/polymer)/(average number of zwitterionic functionalities per dimer/trimer/oligomer/polymer)) is at the most 5,000 g/mol, e.g. at the most 2,000 g/mol, such as at the most 1,000 g/mol.

As for zwitterionic compounds of the oligomer/polymer type, such compounds are typically prepared prior to formulation of the coating composition which is used to prepare the coat. However, it is envisaged that the individual reactive monomers (some or all of which may be reactive monomer carrying a zwitterion functionality) may be used when formulating the coating composition, whereby the actual formation of the oligomer/polymer takes place in the after formulation, e.g. during drying/curing of the coating composition leading to the coat.

If present, the one or more zwitterionic compounds are typically included in the coating composition (and in the cured coat) in an amount of 0.01-20%, e.g. 0.05-15%, by dry weight. In certain embodiments, the one or more zwitterionic compounds constitutes 0.05-10% by dry weight, e.g. 0.1-7% by dry weight, in particular 0.5-5% by dry weight, of the coating composition/cured coat. In certain other embodiments, the one or more zwitterionic compounds 1-10% by dry weight, e.g. 2-9% by dry weight, in particular 2-7% by dry weight, or 3-7% by dry weight, or 3-5% by dry weight, or 4-8% by dry weight, of the coating composition or of the cured coat.

In addition, or alternative, to being added as free zwitterionic compounds (including dimers, trimer, oligomers or polymers), zwitterionic functionalities may also be included as a part of the binder system in the sense that the zwitterionic moieties are covalently attached to the binder matrix. For example, zwitterionic functionalities may be introduced into the polysiloxane-based binder matrix by cross-linking it into the matrix during curing of the coating. This can be achieved by using a reactive compound having included one or more zwitterionic functionalities and in addition to the zwitterionic functionalities containing a reactive group (or groups) that can react with the polysiloxane binder constituents during curing. This reactive group may be a functional silane, e.g. like for poly(2-(methacryloyloxyethyl)-2-(trimethylammoniumethyl)phosphate, inner salt)-co-hydroxypropylmethacrylate)-co-(3-(trimethoxysilyl)propylmethacrylate (76.3:18.3:5.3) (PC2118 ex. Vertellus) and poly(2-(methacryloyloxyethyl)-2-(trimethylammoniumethyl)phosphate, inner salt)-co-(N-dodecylmethacrylate)-co-(hydroxypropylmethacrylate)-co-(3-(trimethoxysilyl)propylmethacrylate) (23:47:25:5) (PC1036 ex. Vertellus). The reactive group may also be a hydroxy group that can cure with an isocyanate functionality, e.g. like for 3-[dimethyl-(2-hydroxyethyl)ammonio]-1-propanesulfonate (NDSB-211 ex. Affymetrix). Alternatively, the zwitterionic moiety may be attached to a polysiloxane binder constituent in a step prior to mixing the binder constituents into the liquid coating composition. This may, e.g., be done by using vinyl functional reactive compounds, e.g. like for poly(2-(methalcyloyloxyethyl)-2-(trimethylammoniumethyl) phosphate, inner salt)-co-(allyl methacrylate) (4:1) (PC1071 ex. Vertellus).

In the variants where the binder matrix has zwitterionic moieties included as a part thereof, any zwitterionic moieties preferably make up 5-35% by weight, such as 6-30% by weight, e.g. 7-25% by weight, of the binder matrix. It should be understood that when calculating the content of the “zwitterionic moieties”, the “zwitterionic moieties” include all atoms up to, but not including, the silicon atom through which the zwitterionic moiety is covalently attached to the polysiloxane parts. (see also above for the calculation of “polysiloxane parts”.)

It should be understood that zwitterionic moieties, when being a part of the binder matrix, typically are present as pendant or terminal groups relative to the backbone chains of the polysiloxane-based binder matrix.

### Biocides

It should be understood that the coat may comprise one biocide, one enzyme, a combination of one biocide and one enzyme, a combination of two biocides, a combination of two enzymes, one or more biocides, one or more enzymes, a combination of one or more biocides and one or more enzymes, etc.

In some important embodiments, the fouling-release coat further comprises one or more biocides. In other embodiments, the fouling-release coat is devoid of biocide. In yet further embodiments, the fouling-release coat comprises a combination of one or more biocides and one or more enzymes.

In the present context, the term “biocide” is intended to mean an active substance intended to destroy, deter, render harmless, prevent the action of, or otherwise exert a controlling effect on any harmful organism by chemical or biological means. However, it should be understood, that the biocide(s)—if present—can be used in combination with one or more enzymes (see below).

Illustrative examples of biocides are those selected from metallo-dithiocarbamates such as bis(dimethyldithiocarbamato)zinc, ethylene-bis(dithiocarbamato)zinc, ethylene-bis(dithio-carbamato)manganese, dimethyl dithiocarbamate zinc, and complexes between these; bis(1-hydroxy-2(1H)-pyridinethionato-O,S)-copper; copper acrylate; bis(1-hydroxy-2(1H)-pyridine-thionato-O,S)-zinc; phenyl(bispyridyl)-bismuth dichloride; metal biocides such as copper(I)oxide, cuprous oxide, metallic copper, copper metal alloys such as copper-nickel alloys like copper bronze; metal salts such as cuprous thiocyanate, basic copper carbonate, copper hydroxide, barium metaborate, copper chloride, silver chloride, silver nitrate and copper sulphide; heterocyclic nitrogen compounds such as 3a,4,7,7a-tetrahydro-2-((trichloromethyl)-thio)-1H-isoindole-1,3(2H)-dione, pyridine-triphenylborane, 1-(2,4,6-trichlorophenyl)-1H-pyrrole-2,5-dione, 2,3,5,6-tetrachloro-4-(methylsulfonyl)-pyridine, 2-methylthio-4-tert-butylamino-6-cyclopropylamine-s-triazin, and quinoline derivatives; heterocyclic sulfur compounds such as 2-(4-thiazolyl)benzimidazole, 4,5-dichloro-2-n-octyl-4-isothiazolin-3-one, 4,5-dichloro-2-octyl-3(2H)-isothiazoline (Sea-Nine®-211N), 1,2-benz-isothiazolin-3-one, and 2-(thiocyanatomethylthio)-benzothiazole; urea derivatives such as N-(1,3-bis(hydroxylmethyl)-2,5-dioxo-4-imidazolidinyl)-N,N′-bis(hydroxymethyl)urea, and N-(3,4-dichlorophenyl)-N,N-dimethylurea, N,N-dimethylchlorophenylurea; amides or imides of carboxylic acids; sulfonic acids and of sulfenic acids such as 2,4,6-trichlorophenyl maleimide, 1,1-dichloro-N-((dimethylamino)sulfonyl)-1-fluoro-N-(4-methylphenyl)-methanesulfenamide, 2,2-dibromo-3-nitrilo-propionamide, N-(fluorodichloromethylthio)-phthalimide, N,N-dimethyl-N′-phenyl-N′-(fluorodichloromethylthio)-sulfamide, and N-methylol formamide; salts or esters of carboxylic acids such as 2-((3-iodo-2-propynyl)oxy)-ethanol phenylcarbamate and N,N-didecyl-N-methyl-poly(oxyethyl)ammonium propionate; amines such as dehydroabiethyl-amines and cocodimethylamine; substituted methane such as di(2-hydroxy-ethoxy)methane, 5,5′-dichloro-2,2′-dihydroxydiphenylmethane, and methylene-bisthiocyanate; substituted benzene such as 2,4,5,6-tetrachloro-1,3-benzenedicarbonitrile, 1,1-dichloro-N-((dimethyl-amino)-sulfonyl)-1-fluoro-N-phenylmethanesulfenamide, and 1-((diiodomethyl)sulfonyl)-4-methyl-benzene; tetraalkyl phosphonium halogenides such as tri-n-butyltetradecyl phosphonium chloride; guanidine derivatives such as n-dodecylguanidine hydrochloride; disulfides such as bis-(dimethylthiocarbamoyl)-disulfide, tetramethylthiuram disulfide; imidazole containing compound, such as medetomidine; 2-(p-chlorophenyl)-3-cyano-4-bromo-5-trifluoromethyl pyrrole; bis(N-cyclohexyl-diazenium dioxy) copper, thiabendazole, N-trihalomethyl thiopthalimides, trihalomethyl thiosulphamides, capsaicin, 3-iodo-2-propynylbutyl carbamate, 1,4-dithiaanthraquinone-2,3-dicarbonitrile (dithianon), furanones such as 3-butyl-5-(dibromomethylidene)-2(5H)-furanone, macrocyclic lactones such as avermectins; and mixtures thereof.

Presently, it is preferred that the biocide (if present) does not comprise tin.

Currently preferred biocides are those selected from the group consisting of 2,4,5,6-tetra-chloroisophtalonitrile (Chlorothalonil), copper thiocyanate (cuprous sulfocyanate), N-dichloro-fluoromethylthio-N′,N′-dimethyl-N-phenylsulfamide (Dichlofluanid), 3-(3,4-dichlorophenyl)-1,1-dimethylurea (Diuron), N²-tert-butyl-N⁴-cyclopropyl-6-methylthio-1,3,5-triazine-2,4-diamine (Cybutryne), 4-bromo-2-(4-chlorophenyl)-5-(trifluoromethyl)-1H-pyrrole-3-carbonitrile, (2-(p-chlorophenyl)-3-cyano-4-bromo-5-trifluoromethyl pyrrole; Tralopyril), N²-tert-butyl-N⁴-cyclopropyl-6-methylthio-1,3,5-triazine-2,4-diamine (Cybutryne), (RS)-4-[1-(2,3-dimethylphenyl)ethyl]-3H-imidazole (Medetomidine), 4,5-dichloro-2-n-octyl-4-isothiazolin-3-one (DCOIT, Sea-Nine® 211N), dichlor-N-((dimethylamino)sulfonyl)fluor-N-(p-tolyl)methansulfenamid (Tolylfluanid), 2-(thiocyanomethylthio)-1,3-benzothiazole ((2-benzothiazolylthio)methyl thiocyanate; TCMTB), triphenylborane pyridine (TPBP); bis(1-hydroxy-2(1H)-pyridinethionato-O,S)-(T-4) zinc (zinc pyridinethione; zinc pyrithione), bis(1-hydroxy-2(1H)-pyridinethionato-O,S)-T-4) copper (copper pyridinethione; copper pyrithione), zinc ethylene-1,2-bis-dithiocarbamate (zinc-ethylene-N—N′-dithiocarbamate; Zineb), copper(i) oxide, metallic copper, 3-(3,4-dichlorophenyl)-1,1-dimethylurea (Diuron) and diiodomethyl-p-tolylsulfone; Amical 48. Preferably at least one biocide is selected from the above list.

In a particularly preferred embodiment, the biocides are preferably selected among biocides which are effective against soft fouling such as slime and algae. Examples of such biocides are N²-tert-butyl-N⁴-cyclopropyl-6-methylthio-1,3,5-triazine-2,4-diamine (Cybutryne), 4,5-dichloro-2-n-octyl-4-isothiazolin-3-one (DCOIT, Sea-Nine® 211N), bis(1-hydroxy-2(1H)-pyridinethionato-O,S)-(T-4) zinc (zinc pyridinethione; zinc pyrithione), bis(1-hydroxy-2(1H)-pyridinethionato-O,S)-T-4) copper (copper pyridinethione; copper pyrithione; Copper Omadine) and zinc ethylene-1,2-bis-dithiocarbamate (zinc-ethylene-N—N′-dithiocarbamate; Zineb), copper(I) oxide, metallic copper, copper thiocyanate, (cuprous sulfocyanate), bis(1-hydroxy-2(1H)-pyridinethionato-O,S)-T-4) copper (copper pyridinethione; copper pyrithione; Copper Omadine).

In some embodiments, at least one biocide is an organic biocide. In a further particularly preferred embodiment, the one or more biocides are organic biocides, such as a pyrithione complex, such as zinc pyrithione, or such as copper pyrithione. In a most preferred embodiment, the biocide is copper pyrithione. Organic biocides are those either fully or in part being of organic origin. In another preferred embodiment one of the biocides is zinc-based. In a specific embodiment thereof, said biocide is zinc ethylene-1,2-bis-dithiocarbamate (zinc-ethylene-N—N′-dithiocarbamate; Zineb).

As detailed in U.S. Pat. No. 7,377,968, in those instances in which the biocide is depleted rapidly from the film due to e.g. a high water solubility or a high level of immiscibility with the matrix composition, it can be advantageous to add one or more of the biocide(s) in encapsulated form as a means of controlling the biocide dosage and extending the effective lifetime in the film. Encapsulated biocides can also be added if the free biocide alters the properties of the polysiloxane matrix in a way that is detrimental for its use as antifouling coatings (e.g. mechanical integrity, drying times, etc.).

In one embodiment, the biocide is encapsulated 4,5-dichloro-2-n-octyl-4-isothiazolin-3-one (Sea-Nine CR2).

The biocide preferably has a solubility in the range of 0-20 mg/L, such as 0.00001-20 mg/L, in water at 25° C.

If present, the biocide typically constitutes 0.1-30% by dry weight, e.g. 0.5-25% by dry weight, in particular 1-20% by dry weight, or 1-15% by dry weight, such as 3-15% by dry weight, of the coating composition or of the cured coat.

The biocide typically constitutes 0.1-25% by solids volume, e.g. 0.5-20% by solids volume, or 1-12% by solids volume, in particular 1-15% by solids volume, of the coating composition.

In another embodiment the biocide constitutes 1-10% by solids volume of the coating composition, such as 2-9%, or 3-8%, or even 4-7% by solids volume of the coating composition.

### Enzymes

In another variant, the active ingredient included in the coat comprises one or more enzymes. In other embodiments, the fouling-release coat is devoid of enzyme. In yet further embodiments, the fouling-release coat comprises a combination of one or more biocides and one or more enzymes.

Even though siloxane-based fouling-release coatings in themselves are very good at hindering settlement of bio-fouling organisms, enzymes can contribute to the overall antifouling ability of the fouling-release system, either by selected targeted mechanisms towards specifically troublesome bio-fouling species, or by a general improvement of the protection mechanism via a broad spectrum antifouling mechanism.

All enzymes capable of preventing settlement of bio-fouling organisms are considered relevant for this invention. However of particular interest are hydrolytic enzymes. Hydrolytic enzymes are those selected from EC class 3. Of particular interest are those selected from the following EC classes:

EC 3.1: ester bonds (esterases: nucleases, phosphodiesterases, lipase, phosphatase)

EC 3.2: sugars (DNA glycosylases, glycoside hydrolase)

EC 3.3: ether bonds

EC 3.4: peptide bonds (Proteases/peptidases)

EC 3.5: carbon-nitrogen bonds, other than peptide bonds

EC 3.6: acid anhydrides (acid anhydride hydrolases, including helicases and GTPase)

EC 3.7: carbon-carbon bonds

EC 3.8: halide bonds

EC 3.9: phosphorus-nitrogen bonds

EC 3.10: sulfur-nitrogen bonds

EC 3.11: carbon-phosphorus bonds

EC 3.12: sulfur-sulfur bonds

EC 3.13: carbon-sulfur bonds

EC 4.2: includes lyases that cleave carbon-oxygen bonds, such as dehydratases

In one embodiment, the one or more enzymes include a hydrolytic enzyme.

In one embodiment, the one or more enzymes are selected from EC classes: EC 3.1, EC 3.2, EC 3.4 and EC 4.2.

In another embodiment, the one or more enzymes are selected from serine proteases, cysteine proteases, metalloproteinase, cellulase, hemicellulase, pectinase, and glycosidases.

Commercial examples of enzymes which are believed to be useful are Savinase (ex Novozymes A/S), Endolase® (ex Novozymes A/S), Alcalase® (ex Novozymes A/S), Esperase® (ex Novozymes), Papain (ex Sigmaaldrich), Subtilisin Carlsberg (ex Sigmaaldrich), pectinase (ex Sigmaaldrich), and polygalacturonase (ex Sigmaaldrich).

In another embodiment, the one or more enzymes include an enzyme which is selected to exert an effect on specific organisms, be it toxic or not. Hence, in this embodiment, the effect of the enzyme may, in addition to being settlement lowering, also affect viability and mortality of the bio-fouling organism in question.

In some interesting embodiments, the one or more enzymes are pre-formulated before being mixed with other paint constituents. For example, the enzymes may be immobilized on or within filler particles, on binder constituents, or—if such constituents are also present—be formulated with hydrophilic mono-, oligo-, or polymers or with hydrophilic-modified polysiloxane oils (see further above).

In one interesting embodiment, the one or more enzymes (or one or some of the one or more enzymes) are formulated, e.g. either by surface treatment or by immobilisation.

In one variant, the one or more enzymes may be entrapped in an aerogel, xerogel, or kryogel-type matrix in a manner similar to that described in WO 2009/062975, in order to obtain stability in the wet paint, compatibility with the cured coat and controlled release of the enzymes when the network of the encapsulation material is degraded by hydrolysis by seawater.

Similarly, the enzymes may be encapsulated in a polymeric material, similar to the material described in U.S. Pat. No. 7,377,968, in order for the enzymes to be shielded from xylene, but not from seawater.

Another way of pre-treating the enzyme is by ionic interaction with either a polyanionic or polycationic material. Depending on the pI of the enzyme, a polymer carrying the suitable charge will affiliate strongly to enzymes giving rise to ionic cross-linking and thus stabilisation of the enzymes.

Adsorption onto a suitable material, such as clay or nitrocellulose, is an alternative way to obtain increased enzyme stability during the preparation, application and curing of an enzyme-containing fouling-release coating.

Establishment of covalent bonds between enzymes, using bifunctional cross-linkers can also potentially improve the enzyme stability. This can be referred to as both cross-linking and co-polymerisation. Cross-linked enzyme aggregates (CLEA®) are commercially available for some of the more common enzymes.

Hence in one embodiment, the one or more enzymes are reacted with a bifunctional cross-linker so as to form enzyme aggregates.

Homo and hetero-bifunctional cross-linkers can be used to immobilise enzymes onto another activated material, such as a binder constituent. Hetero-bifunctional cross-linkers have the advantage of being selective in each end of the molecule. This ensures that the cross-linking only occurs between the molecules of interest. However, homo-bifunctional cross-linkers are also frequently used to immobilise enzymes onto a separate material. Immobilisation of enzymes may be performed before and after film curing, by either binding the enzyme to a precursor of the film or activating a cured film and binding the enzymes to the activated sites.

Also, modification of the surface of enzymes may improve their compatibility with solvents, such as oils or hydrophobic solvents. Poly(ethylene glycol) and fatty acids are commonly applied to render enzymes more compatible with the environments they are intended to be kept in.

Hence in one further embodiment, the enzyme is surface-modified, preferably with Poly(ethylene glycol).

If present, the one or more enzyme applied to prevent settlement of bio-fouling organisms on the polysiloxane-based fouling-release coating system should preferably constitute a maximum of 10 wt %, e.g. 0.0005-8 wt %, such as 0.001-6 wt %, or 0.002-4 wt %, or 0.003-2 wt %, or 0.005-1 wt %, or 0.01-0.1 wt %, of the total weight of the coat, calculated as amount of pure enzyme compared to the total dry weight of the coating composition or the cured coat.

### Specific Embodiments of the Main Aspect of the Invention

In one embodiment the fouling-release coat comprises:

40-98%, such as 60-95%, by dry weight of a polysiloxane-based binder matrix wherein more than 65% by weight of the binder matrix is represented by polysiloxane parts,

0.1-20%, such as 1-10%, by dry weight of one or more additives,

0-25%, such as 0.1-15%, by dry weight of one or more pigments and fillers, and

0.1-20%, such as 1-15%, by dry weight of one or more zwitterionic compounds.

In another embodiment the fouling-release coat comprises:

40-98%, such as 60-95%, by dry weight of a polysiloxane-based binder matrix wherein more than 65% by weight of the binder matrix is represented by polysiloxane parts, said binder matrix having included as a part thereof zwitterionic moieties, in particular in an amount of 5-35%, such as 6-30% or 7-25%, by weight of the binder matrix,

0.1-20%, such as 1-10%, by dry weight of one or more additives, and

0-25%, such as 0.1-15%, by dry weight of one or more pigments and fillers.

In yet another embodiment the fouling-release coat comprises:

40-98%, such as 60-95%, by dry weight of a polysiloxane-based binder matrix wherein more than 65% by weight of the binder matrix is represented by polysiloxane parts, said binder matrix having included as a part thereof zwitterionic moieties, in particular in an amount of 5-35%, such as 6-30% or 7-25%, by weight of the binder matrix,

0.1-20%, such as 1-10%, by dry weight of one or more additives,

0-20%, such as 0.1-15%, by dry weight of one or more pigments and fillers, and

0.1-20%, such as 1-15%, by dry weight of one or more zwitterionic compounds.

In the three above-mentioned embodiments, the coat preferably comprises one or more active ingredients selected from biocides and enzymes, in particular biocide(s), e.g. such that the biocide(s) constitute(s) 0.1-30% by dry weight, e.g. 0.5-25% by dry weight, in particular 1-20% by dry weight, or 1-15% by dry weight, such as 3-15% by dry weight, of the coat.

In yet another embodiment, the fouling-release coat comprises:

40-98%, such as 60-95%, by dry weight of a polysiloxane-based binder matrix wherein more than 65% by weight of the binder matrix is represented by polysiloxane parts,

0.0001-5%, such as 0.001-2%, by dry weight of one or more enzymes,

0.1-15%, such as 1-10%, by dry weight of one or more additives, and

0-20%, such as 1-10% by dry weight of one or more pigments and fillers, and

0.5-20%, such as 1-15%, by dry weight of one or more zwitterionic compounds.

In still embodiment the fouling-release coat comprises:

40-98%, such as 60-95%, by dry weight of a polysiloxane-based binder matrix wherein more than 65% by weight of the binder matrix is represented by polysiloxane parts, said binder matrix having included as a part thereof zwitterionic moieties,

0.0001-5%, such as 0.001-2%, by dry weight of one or more enzymes,

0.1-20%, such as 1-10%, by dry weight of one or more additives, and

0-25%, such as 0.1-15%, by dry weight of one or more pigments and fillers.

### Preparation of Coating Composition

The fouling-release coat is prepared from corresponding coating composition.

Such coating compositions may be prepared by any suitable technique that is commonly used within the field of paint production. Thus, the various constituents may be mixed together utilizing a mixer, a high speed disperser, a ball mill, a pearl mill, a grinder, a three-roll mill etc. The coating compositions are typically prepared and shipped as two- or three-component systems that should be combined and thoroughly mixed immediately prior to use. The paints according to the invention may be filtrated using bag filters, patron filters, wire gap filters, wedge wire filters, metal edge filters, EGLM turnoclean filters (ex. Cuno), DELTA strain filters (ex. Cuno), and Jenag Strainer filters (ex. Jenag), or by vibration filtration. An example of a suitable preparation method is described in the Examples.

The coating composition to be used in the method of the invention is typically prepared by mixing two or more components e.g. two pre-mixtures, one pre-mixture comprising the one or more reactive polysiloxane binders and one pre-mixture comprising the one or more cross-linking agents. It should be understood that when reference is made to the coating composition, it is the mixed coating composition ready to be applied. Furthermore, all amounts stated as % by dry weight of the coating composition should be understood as % by dry weight of the mixed paint composition ready to be applied, i.e. the weight apart from the solvents (if any).

### First Alternative Aspect of the Invention—a Coating System

The present invention also relates to a fouling-release coating system comprising at least a cured first coat and a cured second coat,

a) said first coat comprising a polysiloxane-based binder matrix constituting at least 40% by dry weight of said first coat, and more than 65% by weight of the binder matrix being represented by polysiloxane parts, said first coat further comprising one or more active ingredients selected from biocides and enzymes; and

b) said second coat comprising a polysiloxane-based binder matrix constituting at least 40% by dry weight of said second coat, and more than 65% by weight of the binder matrix being represented by polysiloxane parts, said binder matrix of said second coat having included as a part thereof zwitterionic moieties, and/or said second coat further comprising one or more zwitterionic compounds.

It should be understood that the cured first coat as well as the cured second coat are prepared on a substrate in such a way that the second coat is prepared on top of the first coat. Also, it should be understood that the first coat may be prepared on an already existing coating layer, e.g. an anti-corrosive coating layer, or a tie-coat layer, or an aged antifouling or fouling-release coat, etc., or directly on a native substrate (see further below in the section “Application of coating compositions”. Moreover, although the second coat is preferably the outermost layer, the second coat may in principle be over-coated with a further coating layer (e.g. a top-coat).

Hence, the fouling-release coating system comprises at least a cured first coat and a cured second coat. First, the polysiloxane-based binder matrix which is present in the first coat as well as in the second coat (except that the matrix is not necessarily identical) is described in the above sections “The polysiloxane-based binder matrix”, “Catalysts”, “Solvents, additives, pigments and fillers”, “Hydrophilic modification”, “Zwitterionic functionalities” (where applicable), “Biocides” (where applicable), “Enzymes” (where applicable), and “Specific embodiments . . . ”. Subsequently, the specific features of the first coat is described in the section “The first coat . . . ” below, whereas the specific features of the second coat is further described in the section “The second coat . . . ” further below.

It should be understood that although the first coat and the second coat are of the same type (i.e. polysiloxane-based), the first coat and the second coat are not identical. In particular, it is preferred that the first coat and the second coat differs with respect to at least one of i) the content and/or type of active ingredient(s) (i.e. biocide(s) and/or enzyme(s)), ii) the content and/or type of zwitterionic moieties (of the binder matrix), and iii) the content and/or type of zwitterionic compound(s).

Further embodiments of how the first coat and the second coat are prepared are outlined in the sections “Application of the coating system” and “A marine structure” further below.

### The First Coat of the Coating System

The first coat of the coating system is essentially as described above for the silicone-based fouling-release coat in the section “Main aspect of the invention—The fouling-release coat”, (i) except that the first coat has included therein one ore more active ingredients selected from biocides and enzymes (according to the specification in that section), and (ii) except that the first coat does not have—as a mandatory constituent—included zwitterionic functionalities. Otherwise, the first coat is a described above, mutatis mutandis.

In one embodiment, the first coat comprises:

40-98%, such as 60-95%, by dry weight of a polysiloxane-based binder matrix wherein more than 65% by weight of the binder matrix is represented by polysiloxane parts,

0.1-25%, such as 1-15%, by dry weight of one or more biocides,

0.1-15%, such as 1-10%, by dry weight of one or more additives, and

0-20%, such as 1-10%, by dry weight of one or more pigments and fillers.

In one variant of the above, the first coat comprises zwitterionic moieties (of the binder matrix) or zwitterionic compounds, in particular of the types and in the amounts specified further above.

### The Second Coat of the Coating System

The second coat of the coating system is essentially as described above for the silicone-based fouling-release coat in the section “Main aspect of the invention—The fouling-release coat.

In one embodiment the second coat comprises:

40-98%, such as 60-95%, by dry weight of a polysiloxane-based binder matrix wherein more than 65% by weight of the binder matrix is represented by polysiloxane parts,

0.1-20%, such as 1-10%, by dry weight of one or more additives,

0-25%, such as 0.1-15%, by dry weight of one or more pigments and fillers, and

0.1-20%, such as 1-15%, by dry weight of one or more zwitterionic compounds.

In another embodiment the second coat comprises:

40-98%, such as 60-95%, by dry weight of a polysiloxane-based binder matrix wherein more than 65% by weight of the binder matrix is represented by polysiloxane parts, said binder matrix having included as a part thereof zwitterionic moieties, in particular in an amount of 5-35%, such as 6-30% or 7-25%, by weight of the binder matrix,

0.1-20%, such as 1-10%, by dry weight of one or more additives, and

0-25%, such as 0.1-15%, by dry weight of one or more pigments and fillers.

In yet another embodiment the second coat comprises:

40-98%, such as 60-95%, by dry weight of a polysiloxane-based binder matrix wherein more than 65% by weight of the binder matrix is represented by polysiloxane parts, said binder matrix having included as a part thereof zwitterionic moieties, in particular in an amount of 5-35%, such as 6-30% or 7-25%, by weight of the binder matrix,

0.1-20%, such as 1-10%, by dry weight of one or more additives,

0-20%, such as 0.1-15%, by dry weight of one or more pigments and fillers, and

0.1-20%, such as 1-15%, by dry weight of one or more zwitterionic compounds.

In some variants of the above, the second coat further comprises one or more active ingredients selected from biocides and enzymes, such as one or more biocides, in particular of the types and in the amounts specified further above in the sections “Biocides” and “Enzymes”, respectively.

### Specific Embodiments of the First Alternative Aspect of the Invention

Beside the general aspects of this aspect of the invention, the invention also relates to the following specific embodiments.

Inclusion of active ingredients (i.e. biocide(s) and/or enzyme(s)) in the first coat and zwitterionic compounds in the subsequent coat(s) is believed to improve the resistance towards bio-fouling of said fouling-release system compared to a system where the second coat does not contain zwitterionic compounds. Without being bound to any particular theory, it is believed that the zwitterionic compounds in the outermost coating layer will mobilise the biocide(s)/enzyme(s) during diffusion through the outermost layer.

Hence in one embodiment, the invention provides a fouling-release coating system comprising at least a cured first coat and a cured second coat,

a) said first coat comprising a polysiloxane-based binder matrix constituting at least 40% by dry weight of said first coat, and more than 65% by weight of the binder matrix being represented by polysiloxane parts, said first coat further comprising one or more active ingredients selected from biocides and enzymes; and

b) said second coat comprising a polysiloxane-based binder matrix constituting at least 40% by dry weight of said second coat, and more than 65% by weight of the binder matrix being represented by polysiloxane parts, said second coat further comprising one or more zwitterionic compounds.

In one variant of this embodiment, the cured second coat comprises:

40-98%, such as 60-95%, by dry weight of a polysiloxane-based binder matrix wherein more than 65% by weight of the binder matrix is represented by polysiloxane parts,

0.1-20%, such as 1-10%, by dry weight of one or more additives,

0-25%, such as 0.1-15%, by dry weight of one or more pigments and fillers, and

0.1-20%, such as 1-15%, by dry weight of one or more zwitterionic compounds.

Within this embodiment, it is preferred that the cured second coat comprises one or more zwitterionic compounds in an amount of 0.5-20% by dry weight, such as 1-15%, or 2-10%, or 2-7%, by dry weight of the cured second coat.

Inclusion of active ingredients (i.e. biocide(s) and/or enzyme(s)) in the first coat and binders with zwitterionic moieties in the subsequent coat(s) is believed to improve the resistance towards bio-fouling of said fouling-release system compared to a system where the second coat does not contain zwitterionic moieties as a part of the binder. Without being bound to any particular theory, it is believed that the zwitterionic moieties in the outermost coating layer will mobilise the biocide(s)/enzyme(s) during diffusion through the outermost layer.

Hence in another embodiment, the invention provides a fouling-release coating system comprising at least a cured first coat and a cured second coat,

a) said first coat comprising a polysiloxane-based binder matrix constituting at least 40% by dry weight of said first coat, and more than 65% by weight of the binder matrix being represented by polysiloxane parts, said first coat further comprising one or more active ingredients selected from biocides and enzymes; and

b) said second coat comprising a polysiloxane-based binder matrix constituting at least 40% by dry weight of said second coat, and more than 65% by weight of the binder matrix being represented by polysiloxane parts, said binder matrix of said second coat having included as a part thereof zwitterionic moieties.

In one variant of this embodiment, the cured second coat comprises:

40-98%, such as 60-95%, by dry weight of a polysiloxane-based binder matrix wherein more than 65% by weight of the binder matrix is represented by polysiloxane parts, said binder matrix having included as a part thereof zwitterionic moieties, in particular in an amount of 5-35%, such as 6-30% or 7-25%, by weight of the binder matrix,

0.1-20%, such as 1-10%, by dry weight of one or more additives, and

0-25%, such as 0.1-15%, by dry weight of one or more pigments and fillers.

In both of the above embodiment, it is preferred that the cured first coat comprises:

40-98%, such as 60-95%, by dry weight of a polysiloxane-based binder matrix wherein more than 65% by weight of the binder matrix is represented by polysiloxane parts,

0.1-25%, such as 1-15%, by dry weight of one or more biocides,

0.1-15%, such as 1-10%, by dry weight of one or more additives, and

0-20%, such as 1-10%, by dry weight of one or more pigments and fillers.

In some variants of the above embodiments, the cured second coat comprises:

40-98%, such as 60-95%, by dry weight of a polysiloxane-based binder matrix wherein 5-35%, such as 6-30% or 7-25%, by weight of the binder matrix is represented by zwitterionic moieties,

0.1-20%, such as 1-10%, by dry weight of one or more additives,

0-20%, such as 0.1-15%, by dry weight of one or more pigments and fillers, and

0.1-20%, such as 1-15%, by dry weight of one or more zwitterionic compounds.

In some variants of the above, the second coat further comprises one or more active ingredients selected from biocides and enzymes, in particular biocides, in particular of the types and in the amounts specified further above in the sections “Biocides” and “Enzymes”, respectively.

### Application of the Coating Composition

The coating composition of the invention is typically applied to at least a part of the surface of a substrate.

The term “applying” is used in its normal meaning within the paint industry. Thus, “applying” is conducted by means of any conventional means, e.g. by brush, by roller, by spraying, by dipping, etc. The commercially most interesting way of “applying” the coating composition is by spraying. Hence, the coating composition is preferably sprayable. Spraying is effected by means of conventional spraying equipment known to the person skilled in the art. The coating is typically applied in a dry film thickness of 50-600 μm, such as 50-500 μm, e.g. 75-400 μm, or 20-150 μm, or 30-100 μm.

Moreover, the coating composition is preferably such with respect to sag resistance cf. ASTM D 4400-99 (i.e. relating to its ability to be applied in a suitable film thickness to a vertical surface without sagging) that it exhibits sag resistance for a wet film thickness up to at least 70 μm, such as up to at least 200 μm, e.g. up to at least 300 μm, preferably up to at least 400 μm, and in particular up to at least 600 μm.

The term “at least a part of the surface of a substrate” refers to the fact that the coating composition may be applied to any fraction of the surface. For many applications, the coating composition is at least applied to the part of the substrate (e.g. a vessel) where the surface (e.g. the ship's hull) may come in contact with water, e.g. sea-water.

The term “substrate” is intended to mean a solid material onto which the coating composition is applied. The substrate typically comprises a metal such as steel, iron, aluminium, or glass-fibre reinforced polyester. In the most interesting embodiments, the substrate is a metal substrate, in particular a steel substrate. In an alternative embodiment, the substrate is a glass-fibre reinforced polyester substrate. In some embodiments, the substrate is at least a part of the outermost surface of a marine structure.

The term “surface” is used in its normal sense, and refers to the exterior boundary of an object. Particular examples of such surfaces are the surface of marine structures, such as vessels (including but not limited to boats, yachts, motorboats, motor launches, ocean liners, tugboats, tankers, container ships and other cargo ships, submarines, and naval vessels of all types), pipes, shore and off-shore machinery, constructions and objects of all types such as piers, pilings, bridge substructures, water-power installations and structures, underwater oil well structures, nets and other aquatic culture installations, and buoys, etc.

The surface of the substrate may either be the “native” surface (e.g. the steel surface). However, the substrate is typically coated, e.g. with an anticorrosive coating and/or a tie coat, so that the surface of the substrate is constituted by such a coating. When present, the (anticorrosive and/or tie) coating is typically applied in a total dry film thickness of 100-600 μm, such as 150-450 μm, e.g. 200-400 μm. Alternatively, the substrate may carry a paint coat, e.g. a worn-out fouling-release paint coat, or similar.

In one important embodiment, the substrate is a metal substrate (e.g. a steel substrate) coated with an anticorrosive coating such as an anticorrosive epoxy-based coating, e.g. cured epoxy-based coating, or a shop-primer, e.g. a zinc-rich shop-primer. In another relevant embodiment, the substrate is a glass-fiber reinforced polyester substrate coated with an epoxy primer coating.

The coat of the main aspect of the invention is typically applied as the outermost coat (a.k.a. a top-coat), i.e. the coat being exposed to the environment, e.g. an aquatic environment. However, it should be understood that the coat of the main aspect of the invention alternatively may be applied as a layered system where the coat described in the main aspect of this invention will be coated with one or more layer(s) of one or more other coating compositions in order to obtain an improve control of the leaching rate of the leachable components in the coat.

This being said, the invention also relates to a method of establishing a fouling-release coating system on a surface of a substrate, comprising the sequential steps of:

a) applying one or more layers of a primer composition onto the surface of said substrate, thereby forming a primed substrate,

b) applying one or more layers of a tie-coat composition onto the surface of said primed substrate, and allowing said layer(s) to cure, thereby forming a cured tie-coat, and

c) applying one or more layers of a composition onto the surface of said cured tie-coat, and allowing said layer(s) to cure, thereby forming a cured fouling-release coat as defined hereinabove (main aspect).

In some variants of the above-mentioned method, the cure fouling-release coat may be further coated with a top-coat, e.g. a PDMS-based top-coat.

This being said, the invention also relates to a method of establishing a fouling-release coating system on a surface of a substrate (according to the first alternative aspect), comprising the sequential steps of:

a) applying one or more layers of a polysiloxane-based coating composition onto the surface of said substrate, e.g. either a native substrate or a substrate already carrying one or more coatings, as the case may be, and allowing said layer(s) to cure, thereby forming a cured first coat as defined hereinabove for the first alternative aspect, and

b) applying one or more layers of a polysiloxane-based coating composition onto the surface of said cured first coat, and allowing said layer(s) to cure, thereby forming a cured second coat as defined hereinabove for the first alternative aspect.

The invention also relates to a method of establishing a fouling-release coating system on a surface of a substrate (according to the first alternative aspect), comprising the sequential steps of:

a) applying one or more layers of a primer composition onto the surface of said substrate, and allowing said layer(s) to cure, thereby forming a primed substrate,

b) optionally applying one or more layers of a tie-coat composition onto the surface of said primed substrate, and allowing said layer(s) to cure, thereby forming a cured tie-coat;

c) applying one or more layers of a polysiloxane-based coating composition onto the surface of said primed substrate or the surface of said tie-coat, as the case may be, and allowing said layer(s) to cure, thereby forming a cured first coat as defined hereinabove for the first alternative aspect, and

d) applying one or more layers of a polysiloxane-based coating composition onto the surface of said cured first coat, and allowing said layer(s) to cure, thereby forming a cured second coat as defined hereinabove for the first alternative aspect.

The invention further relates to a method of establishing a fouling-release coating system on a surface of an aged antifouling coating system, comprising the sequential steps of:

a) applying one or more layers of a sealer/link-coat composition onto the surface of said substrate, allowing said layer(s) to cure, thereby forming a sealed substrate,

b) optionally applying one or more layers of a tie-coat composition onto the surface of said sealed substrate, and allowing said layer(s) to cure, thereby forming a cured tie-coat;

c) applying one or more layers of a polysiloxane-based coating composition onto the surface of said primed substrate or the surface of said tie-coat, as the case may be, and allowing said layer(s) to cure, thereby forming a cured first coat as defined hereinabove for the first alternative aspect, and

d) applying one or more layers of a polysiloxane-based coating composition onto the surface of said cured first coat, and allowing said layer(s) to cure, thereby forming a cured second coat as defined hereinabove for the first alternative aspect.

The invention further relates to a method of establishing a fouling-release coating system on a surface of an aged fouling-release coating system, comprising the sequential steps of:

a) optionally applying one or more layers of a tie-coat composition onto the surface of said aged fouling-release coating system, and allowing said layer(s) to cure, thereby forming a cured tie-coat;

b) applying one or more layers of a polysiloxane-based coating composition onto the surface of said primed substrate or the surface of said tie-coat, as the case may be, and allowing said layer(s) to cure, thereby forming a cured first coat as defined hereinabove for the first alternative aspect, and

c) applying one or more layers of a polysiloxane-based coating composition onto the surface of said cured first coat, and allowing said layer(s) to cure, thereby forming a cured second coat as defined hereinabove for the first alternative aspect.

### A Marine Structure

The present invention also provides a marine structure comprising on at least a part of the outer surface thereof an outermost fouling-release coating system as defined hereinabove. In particular, at least as part of the outer surface carrying the outermost coating is a submerged part of said structure.

The coating composition, the method of establishing the coating on the substrate surface, and the characteristics of the coating follow the directions given hereinabove.

In one embodiment, the fouling-release coating system of the marine structure may consist of an anticorrosive layer, a tie-coat and the fouling-release coating system as described herein.

In an alternative embodiment, the fouling-release coating composition is applied on top of a used fouling-release coating system, e.g. on top of a used polysiloxane-based fouling-release coat.

In one particular embodiment of the above marine structure, the anticorrosive layer has a total dry film thickness of 100-600 μm, such as 150-450 μm, e.g. 200-400 μm; the tie-coat has a total dry film thickness of 50-500 μm, such as 50-400 μm, e.g. 75-350 μm or 75-300 μm or 75-250 μm; and the fouling-release coating has a total dry film thickness of 20-500 μm, such as 20-400 μm, e.g. 50-300 μm.

A further embodiment of the marine structure is that where at least a part of the outermost surface of said structure is coated with a fouling-release coating system comprising

a total dry film thickness of 150-400 μm of an anticorrosive layer of an epoxy-based coating established by application of 1-4, such as 2-4, layers;

a total dry film thickness of 20-400 μm of the tie-coat established by application of 1-2 layers; and

a total dry film thickness of 20-400 μm of the fouling-release coating (according to the main aspect) established by application of 1-2 layers.

A further embodiment of the marine structure is that where at least a part of the outermost surface of said structure is coated with a fouling-release coating system (first alternative aspect) comprising

a total dry film thickness of 150-400 μm of an anticorrosive layer of an epoxy-based coating established by application of 1-4, such as 2-4, layers;

a total dry film thickness of 20-400 μm of the tie-coat established by application of 1-2 layers;

a total dry film thickness of 20-400 μm of the first coat (cf. the first alternative aspect) of the fouling-release coating established by application of 1-2 layers;

a total dry film thickness of 20-400 μm of the second coat (cf. the first alternative aspect) of the fouling-release coating established by application of 1-2 layers.

In another embodiment of the above marine structures, the fouling-release coating is applied directly on the anticorrosive layer without the use of tie-coat.

### Coating Compositions

A further aspect of the invention relates to a fouling-release coating composition comprising a polysiloxane-based binder system, said binder system comprising one or more polysiloxane components having included as a part thereof zwitterionic moieties, and one or more active ingredients selected from biocides and enzymes, and wherein more than 65% by weight of the binder system is represented by polysiloxane parts. In particular, the zwitterionic moieties are selected from zwitterion functionalities of the phosphorylcholine type, the sulfobetaine type and the carboxybetaine type.

A still further aspect of the invention relates to a fouling-release coating composition comprising a polysiloxane-based binder system, one or more zwitterionic compounds, and one or more active ingredients selected from biocides and enzymes, wherein more than 65% by weight of the binder system is represented by polysiloxane parts. In particular, the one or more zwitterionic compounds contain zwitterion functionalities of the phosphorylcholine type, the sulfobetaine type or the carboxybetaine type.

In general, the invention relates to fouling-release coating compositions corresponding the defined coats of the main aspect and the first coat and second coats of the first alternative aspect, cf. above. These coating compositions have for all practical purposes the same composition in terms of “dry weight” as the corresponding coats.

### Uses

A further aspect of the invention relates to the use of the combination of constituents having included one or more zwitterionic functionalities and one or more active ingredients selected from biocides and enzymes, for improving the antifouling properties of a polysiloxane based coating composition.

A further aspect of the invention relates to the use of the combination of one or more polysiloxane components having included as a part thereof zwitterionic moieties, and one or more active ingredients selected from biocides and enzymes, for improving the antifouling properties of a polysiloxane based coating composition.

A still further aspect of the invention relates to the use of the combination of one or more polysiloxane components, one or more zwitterionic compounds, and one or more active ingredients selected from biocides and enzymes, for improving the antifouling properties of a polysiloxane based coating composition.

### General Remarks

Although the present description and claims occasionally refer to a polysiloxane, etc., it should be understood that the coating compositions defined herein may comprise one, two or more types of the individual constituents. In such embodiments, the total amount of the respective constituent should correspond to the amount defined above for the individual constituent.

The “(s)” in the expressions: compound(s), polysiloxane(s), agent(s), etc. indicates that one, two or more types of the individual constituents may be present.

On the other hand, when the expression “one” is used, only one (1) of the respective constituent is present.

It should be understood that the expression “% dry weight” means the percentage of the respective component based on the dry weight of the coat or of the coating composition, as the case may be. For most practical purposes (hence, unless otherwise stated), the “% dry weight” when referring the cured coat is identical to the “% dry weight” of the coating composition.

### Examples

### Viscosity

In the context of the present application with claims, viscosity is measured at 25° C. in accordance with ISO 2555:1989.

### Preparation Method for the Model Paints

Part (i): binder, solvents, pigments, biocides (if needed) and additives are mixed on a Diaf dissolver equipped with an impeller disc (e.g. 70 mm diameter impeller disc in a 1 L can for 15 minutes at 2000 rpm).

Part (ii): ethyl silicate, solvents, catalyst, and 2,4-pentanedione are mixed on a Diaf dissolver equipped with an impeller disc (e.g. 70 mm diameter impeller disc in a 1 L can for 2 minutes at 500 rpm).

Before the application, part (i) and part (ii) are mixed together with any zwitterionic compounds and/or the binder constituents (including any constituents giving rise to zwitterionic moieties) according to the compositions provided in the examples, where after the mix is then stirred to obtain homogeneity.

Test Methods

### Raft Test

### Preparation of Panels

An acrylic panel (150×200 mm), sandblasted on one side to facilitate adhesion of the coating, is coated with 100 μm (DFT) of a commercial epoxy (HEMPEL Light Primer 45551) applied by air spraying. After 6-24 hours of drying at room temperature a tie coat is applied by doctor blade of 300 μm clearance. After 16-30 hours of drying the top coat paint compositions are applied by doctor blade of 400 μm clearance. The panels are dried for at least 72 hours before immersion on the raft.

### Testing

Panels are tested at two different locations; Spain and Singapore.

Test site in Spain: Located in Vilanova in north-eastern Spain. At this test site the panels are immersed into sea water with salinity in the range of 37-38 parts per thousand at an average temperature of 17-18° C.

Test site in Singapore: At this test site the panels are immersed into sea water with salinity in the range of 29-31 parts per thousand at a temperature in the range of 29-31° C.

Panels are inspected ever 4-12 weeks and evaluated according to the following scale for each of the fouling types; Animals, algae and slime:

| Score | Fouled area (%) |
|---|---|
| 0 | 0 |
| 1 | 0-2% |
| 2 | 3-5% |
| 3 | 6-25% |
| 4 | 26-50% |
| 5 | 51-100% |

### Examples

The following model paints can be prepared for testing for antifouling performance. All entries in model paints table are in weight unless otherwise stated. In the calculation of the final polysiloxane matrix, all the hydrolysable groups are presumed completely hydrolysed and reacted into a matrix through a condensation reaction with the polysiloxane binder. Therefore, the ethyl silicate contributes with 41% of its weight to the calculations of the final polysiloxane matrix and vinyltrimethoxysilane contributes with 54% of its weight correspondingly. When calculating the polysiloxane content of the binder matrix, the constituents are included in the calculations as the starting materials, however with the above-mentioned corrections for ethyl silicate and vinyltrimethoxysilane.

### Materials

RF-5000, ex. Shin-Etsu—Japan, silanol-terminated polydimethylsiloxane

Xylene from local supplier

Aerosil R972, ex. Evonik industries

Silikat TES 40 WN, ex. Wacker chemie—Germany, ethyl silicate

Neostann U-12, ex. Nitto, Kasai—Japan, Dibutyltin dilaurate

Acetylaceton, ex. Wacker Chemie—Germany, 2,4-pentanedione

Bayferrox 130M, ex. Lancess—Germany, Iron oxide

Copper Omadine, ex. Arch Chemicals Inc.—Ireland, Copper Pyrithione

Fumed silica

Polyamide wax

PC2118, phosphorylcholine copolymer with methoxy silane reactivity ex. Vertellus

PC1036, phosphorylcoline copolymer with methoxy silane reactivity ex. Vertellus

PC1059, phosphorylcholing copolymer non-reactive ex. Vertellus

Zink Omadine, ex. Arch Chemicals Inc.—Ireland, Zink Pyrithione

DMODAPS; 3-(N,N-dimethyloctadecylammonio)propanesulfonate, e.g. Sigma-Aldrich

Empigen, Empigen® BB detergent, ex. Sigma Aldrich (Cas nr 66455-29-6)

Savinase 16L (type EX), ex. Novozymes

Endolase 5000L, ex. Novozymes

PC3019. Phosphorylcholine—PDMS block copolymer ex. Vertellus

PC3054 Phosphorylcholine—PDMS block copolymer ex. Vertellus

### Base 1

| | | |
|---|---|---|
| Part i | RF-5000 silanol-terminated | 66.7 g |
| | polysiloxane | |
| | Xylene | 21.8 g |
| | Polyamide wax | 2.3 g |
| | Bayferrox 130M | 4.3 g |
| | Copper Omadine | 5 g |
| sum | | 100.1 g |

### Base 2

| | | |
|---|---|---|
| Part i | RF-5000 silanol-terminated | 66.7 g |
| | polysiloxane | |
| | Xylene | 21.8 g |
| | Polyamide wax | 2.3 g |
| | Bayferrox 130M | 9.3 g |
| sum | | 100.1 g |

### Base 3

| | | |
|---|---|---|
| Part i | RF-5000 silanol-terminated | 66.7 g |
| | polysiloxane | |
| | Xylene | 21.8 g |
| | Polyamide wax | 2.3 g |
| | Bayferrox 130M | 4.3 g |
| | Zink Omadine | 5 g |
| sum | | 100.1 g |

### Curing Agent 1

| | | |
|---|---|---|
| Part ii | Silikat TES 40WN | 60.5 g |
| | Acetylaceton | 28.9 g |
| | Neostann U-12 | 10.5 g |
| sum | | 99.9 g |

Note that the PC components were added as a mixture in ethanol. The dry-matter content of this mixture is presented in the tables below. In the tables, ZF* refers to the (reactive) compound used to introduce the zwitterion functionalities.

| | | | | Antifouling performance | |
|---|---|---|---|---|---|
| | Composition | | | After 23 weeks | After 16 weeks |
| | Base | Curing | | in Spain | in Singapore |
| | (Biocide) | agent | ZF* | (animal fouling) | (animal fouling) |
| Ref | 96 g Base 1 | 4 g | | 0 | 5 |
| 1 | (CuPt) | C.A. 1 | | | |
| 2 | 90.9 g Base 1 | 3.6 g | 5.5 g | 0 | 2 |
| | (CuPt) | C.A. 1 | PC1036¹ | | |
| 3 | 90.9 g Base 1 | 3.6 g | 5.5 g | 0 | 3 |
| | (CuPt) | C.A. 1 | PC2118¹ | | |
| 4 | 90.9 g Base 1 | 3.6 g | 5.5 g | 0 | 2 |
| | (CuPt) | C.A. 1 | PC1059² | | |
| 5 | 85.6 g Base 1 | 3.4 g | 11.0 g | 0 | 4 |
| | (CuPt) | C.A. 1 | PC1036¹ | | |
| 6 | 85.6 g Base 1 | 3.4 g | 11.0 g | 0 | 1 |
| | (CuPt) | C.A. 1 | PC2118¹ | | |
| 7 | 85.6 g Base 1 | 3.4 g | 11.0 g | 0 | 3 |
| | (CuPt) | C.A. 1 | PC1059² | | |

¹Reactive zwitterionic moiety
²Zwitterionic compound

The examples show that the addition of zwitterionic moieties to siloxane-based fouling-release coatings containing biocides further enhances the antifouling performance of the coating compared to the zwitterionic free, biocide containing reference. This is the case for reactive zwitterionic moieties as well as non-reactive zwitterionic compounds.

| | | | | Antifouling performance |
|---|---|---|---|---|
| | Composition | | | After 23 weeks in |
| | | Curing | | Spain |
| | Base | agent | ZF* | (animal fouling) |
| Ref | 96.3 g Base 2 | 3.8 g | | 3 |
| 8 | | C.A. 1 | | |
| 9 | 92.8 g Base 2 | 3.7 g | 3.6 g | 2 |
| | | C.A. 1 | PC2118¹ | |
| 10 | 92.8 g Base 2 | 3.7 g | 3.6 g | 2 |
| | | C.A. 1 | PC1059² | |
| 11 | 89.2 g Base 2 | 3.5 g | 7.3 g | 2 |
| | | C.A. 1 | PC1036¹ | |
| 12 | 89.2 g Base 2 | 3.5 g | 7.3 g | 1 |
| | | C.A. 1 | PC2118¹ | |
| 13 | 89.2 g Base 2 | 3.5 g | 7.3 g | 2 |
| | | C.A. 1 | PC1059² | |

¹Reactive zwitterionic moiety
²Zwitterionic compound

The examples show that addition of zwitterionic compounds and zwitterionic moieties attached to the binder system enhances the antifouling performance of siloxane-based fouling-release coatings.

| | | | | | Antifouling performance | |
|---|---|---|---|---|---|---|
| | Composition | | | | After 14 weeks in | After 8 weeks in |
| | Base | | | | Spain | Singapore |
| | (Biocide) | Curing agent | ZF* | Enzyme | (animal fouling) | (animal fouling) |
| 1 | 92.7 g Base 2 | 3.7 g C.A. 1 | 3.6 g DMODAPS | | 2 | 3 |
| 3 | 90.9 g Base 3 | 3.6 g C.A. 1 | 5.5 g DMODAPS | | 0 | 1 |
| | (ZnPt) | | | | | |
| 5 | 92.7 g Base 2 | 3.7 g C.A. 1 | 3.6 g DMODAPS | 0.01 g | 0 | 4 |
| | | | | Savinase | | |
| 7 | 92.7 g Base 2 | 3.7 g C.A. 1 | 3.6 g DMODAPS | 0.01 g | 0 | 4 |
| | | | | Endolase | | |

The example shows that DMODAPS works as a zwitterionic moiety and that combining biocides or enzymes improves the control of animal fouling.

| | | | | | Antifouling performance | |
|---|---|---|---|---|---|---|
| | Composition | | | | After 14 weeks in | After 8 weeks in |
| | Base | | | | Spain | Singapore |
| | (Biocide) | Curing agent | ZF* | Enzyme | (animal fouling) | (animal fouling) |
| 12 | 92.7 g Base 2 | 3.7 g C.A. 1 | 3.6 g PC1059 | | 0 | 5 |
| 13 | 92.7 g Base 2 | 3.7 g C.A. 1 | 3.6 g PC1059 | 0.01 g | 0 | 4 |
| | | | | Savinase | | |

The example shows that combining zwitterionic moieties with enzymes improve the control of animal fouling.

| | | | | | Antifouling performance | |
|---|---|---|---|---|---|---|
| | | | | | | After 8 weeks in |
| | Composition | | | | After 14 weeks in | Singapore |
| | Base | | | | Spain | (Short algal |
| | (Biocide) | Curing agent | ZF* | Enzyme | (animal fouling) | fouling) |
| 2 | 86.9 g Base 2 | 3.5 g C. A. 1 | 9.6 g Empigen | | 0 | 3 |
| 4 | 82.5 g Base 3 | 3.3 g C.A. 1 | 14.3 g Empigen | | 0 | 2 |
| | (ZnPt) | | | | | |

The example shows that Empigen also works as a zwitterionic moiety

| | | | | | | | | | Antifouling performance | |
|---|---|---|---|---|---|---|---|---|---|---|
| | Composition | | | | Composition 2nd Layer | | | | After 5 weeks in | After 8 weeks in |
| | Base | Curing | | | Base | Curing | | | Spain | Singapore (animal |
| | (Biocide) | agent | ZF* | Enzyme | (Biocide) | agent | ZF* | Enzyme | (animal fouling) | fouling) |
| 2 | 96.2 g | 3.8 g C. | | | 92.7 g | 3.7 g | 3.6 g | | 1 | 4 |
| | Base 2 | A. 1 | | | Base 2 | C.A. 1 | PC2118 | | | |
| 3 | 96 g Base | 4 g C.A. 1 | | | 92.7 g | 3.7 g | 3.6 g | | 1 | 2 |
| | 3 (ZnPT) | | | | Base 2 | C.A. 1 | PC2118 | | | |
| 4 | 96.2 g | 3.8 g C. | | | 92.7 g | 3.7 g | 3.6 g | | 2 | 2 |
| | Base 2 | A. 1 | | | Base 2 | C.A. 1 | DMODAPS | | | |
| 5 | 96 g Base | 4 g C.A. 1 | | | 92.7 g | 3.7 g | 3.6 g | | 0 | 1 |
| | 3 (ZnPT) | | | | Base 2 | C.A. 1 | DMODAPS | | | |
| 13 | 96 g Base | 4 g C.A. 1 | | | 92.7 g | 3.7 g | 3.6 g | | 0 | 1 |
| | 1 (CuPT) | | | | Base 2 | C.A. 1 | DMODAPS | | | |

The Example shows that the zwitterionic moiety and the biocide can be separated into two layers of coating.

| | | | | | | | | | Antifouling performance | |
|---|---|---|---|---|---|---|---|---|---|---|
| | Composition | | | | Composition 2nd Layer | | | | After 5 weeks in | After 8 weeks in |
| | Base | Curing | | | Base | Curing | | | Spain | Singapore (animal |
| | (Biocide) | agent | ZF* | Enzyme | (Biocide) | agent | ZF* | Enzyme | (animal fouling) | fouling) |
| 9 | 96 g Base | 4 g C.A. 1 | | | 92.7 g | 3.7 g | 3.6 g | | 1 | 2 |
| | 1 (CuPT) | | | | Base 2 | C.A. 1 | PC2118 | | | |
| 10 | 96 g Base | 4 g C.A. 1 | | | 92.7 g | 3.7 g | 3.6 g | 0.01 g | 0 | 2 |
| | 1 (CuPT) | | | | Base 2 | C.A. 1 | PC2118 | Savinase | | |

The example shows that adding enzymes to the top-layer improves the control over animal fouling—

| | | | | | | | | | Antifouling performance | |
|---|---|---|---|---|---|---|---|---|---|---|
| | Composition | | | | Composition 2nd Layer | | | | After 5 weeks in | After 8 weeks in |
| | Base | Curing | | | Base | Curing | | | Spain | Singapore (animal |
| | (Biocide) | agent | ZF* | Enzyme | (Biocide) | agent | ZF* | Enzyme | (animal fouling) | fouling) |
| 2 | 96.2 g | 3.8 g C. | | | 92.7 g | 3.7 g | 3.6 g | | 1 | 4 |
| | Base 2 | A. 1 | | | Base 2 | C.A. 1 | PC2118 | | | |
| 3 | 96 g Base | 4 g C.A. 1 | | | 92.7 g | 3.7 g | 3.6 g | | 1 | 2 |
| | 3 (ZnPT) | | | | Base 2 | C.A. 1 | PC2118 | | | |
| 12 | 90.9 g | 3.6 g | 5.5 g | | 92.7 g | 3.7 g | 3.6 g | | 2 | 1 |
| | Base 3 (ZnPT) | C.A. 1 | PC1059 | | Base 2 | C.A. 1 | PC2118 | | | |

| | | | | | Antifouling |
|---|---|---|---|---|---|
| | | | | | performance |
| | Composition | | | | After 14 weeks in |
| | Base | | | | Spain |
| | (Biocide) | Curing agent | ZF* | Enzyme | (animal fouling) |
| 2 | 92.5 g Base 1 | 7.5 g. C.A. 1 | | | 2 |
| | (CuPT) | | | | |
| 4 | 88.8 g Base 2 | 7.7 g C.A. 1 | 3.4 g PC3019 | | 2 |
| 5 | 85.6 g Base 2 | 7.4 g C.A. 1 | 7.0 g PC3054 | | 2 |
| 6 | 85.6 g Base 2 | 7.4 g C.A. 1 | 7.0 g PC3019 | | 2 |
| 9 | 86.0 g Base 1 | 7.0 g C.A. 1 | 7.0 g PC3054 | | 1 |
| | (CuPT) | | | | |
| 10 | 86.0 g Base 1 | 7.0 g C.A. 1 | 7.0 g PC3019 | | 1 |
| | (CuPT) | | | | |
| 12 | 85.5 g Base 2 | 7.4 g C.A. 1 | 3.3 g PC3019 | 3.7 g Savinase | 1 |

The example shows the efficacy of zwitterionic moieties combined with biocides or enzymes

| | | | | | | Antifouling |
|---|---|---|---|---|---|---|
| | | | | | | performance |
| | Composition | | Composition 2nd Layer | | | fter 5 weeks in |
| | Base | | Base | | | Spain |
| | (Biocide) | Curing agent | (Biocide) | Curing agent | ZF* | (animal fouling) |
| 13 | 92.5 g Base 1 | 7.5 g C.A. 1 | 88.8 g | 7.7 g C.A. 1 | 3.4 g | 1 |
| | (CuPT) | | Base 2 | | PC3054 | |
| 14 | 92.5 g Base 1 | 7.5 g C.A. 1 | 85.6 g | 7.4 g C.A. 1 | 7.0 g | 1 |
| | (CuPT) | | Base 2 | | PC3054 | |
| 3 | | | 88.8 g | 7.7 g C.A. 1 | 3.4 g | 2 |
| | | | Base 2 | | PC3054 | |
| 5 | | | 85.6 g | 7.4 g C.A. 1 | 7.0 g | 2 |
| | | | Base 2 | | PC3054 | |

The example shows the efficacy of having a layer containing biocides underneath the layer with zwitterionic moieties.

1. A silicone-based fouling-release coat comprising a polysiloxane-based binder matrix constituting at least 40% by dry weight of said coat, wherein more than 65% by weight of said binder matrix is represented by polysiloxane parts, said binder matrix of said coat having included as a part thereof zwitterionic moieties and/or said coat comprising one or more zwitterionic compounds, and said coat further comprising one or more active ingredients selected from biocides and enzymes.

2. The fouling-release coat according to claim 1, wherein the fouling-release coat comprises 1-15% by weight of one or more biocides.

3. The fouling-release coat according to claim 1, wherein the fouling-release coat further comprises 5-40% by weight of one or more pigments.

4. The fouling-release coat according to claim 1, wherein said binder matrix of said coat has included as a part thereof zwitterionic moieties.

5. The fouling-release coat according to claim 1, wherein said coat comprises one or more zwitterionic compounds.

6. A marine structure comprising on at least a part of the outer surface thereof a paint coat as defined in claim 1.

7. The structure according to claim 6, wherein at least a part of the outer surface carrying the outermost coating is a submerged part of said structure.

8. A fouling-release coating composition comprising a polysiloxane-based binder system, said binder system comprising one or more polysiloxane components having included as a part thereof zwitterionic moieties, and one or more active ingredients selected from biocides and enzymes, and wherein more than 65% by weight of the binder system is represented by polysiloxane parts.

9. A fouling-release coating composition comprising a polysiloxane-based binder system, one or more zwitterionic compounds, and one or more active ingredients selected from biocides and enzymes, wherein more than 65% by weight of the binder system is represented by polysiloxane parts.

10. A method for improving the antifouling properties of a polysiloxane based coating composition, said method comprising including in said polysiloxane based coating composition a combination of one or more polysiloxane components having included as a part thereof zwitterionic moieties, and one or more active ingredients selected from biocides and enzymes.

11. A method for improving the antifouling properties of a polysiloxane based coating composition, said method comprising including in said polysiloxane based coating composition a combination of one or more polysiloxane components, one or more zwitterionic compounds, and one or more active ingredients selected from biocides and enzymes.

12. A silicone-based fouling-release coat comprising a polysiloxane-based binder matrix constituting at least 40% by dry weight of said coat, wherein more than 65% by weight of said binder matrix is represented by polysiloxane parts, said binder matrix of said coat having included as a part thereof zwitterionic moieties and/or said coat comprising one or more zwitterionic compounds.

13. A fouling-release coating system comprising at least a cured first coat and a cured second coat,
a) said first coat comprising a polysiloxane-based binder matrix constituting at least 40% by dry weight of said first coat, and more than 65% by weight of the binder matrix being represented by polysiloxane parts, said first coat further comprising one or more active ingredients selected from biocides and enzymes; and
b) said second coat comprising a polysiloxane-based binder matrix constituting at least 40% by dry weight of said second coat, and more than 65% by weight of the binder matrix being represented by polysiloxane parts, said binder matrix of said second coat having included as a part thereof zwitterionic moieties, and/or said second coat further comprising one or more zwitterionic compounds.

14. The fouling-release coat according to claim 2, wherein said binder matrix of said coat has included as a part thereof zwitterionic moieties.

15. The fouling-release coat according to claim 3, wherein said binder matrix of said coat has included as a part thereof zwitterionic moieties.

16. The fouling-release coat according to claim 2, wherein said coat comprises one or more zwitterionic compounds.

17. The fouling-release coat according to claim 3, wherein said coat comprises one or more zwitterionic compounds.
